(19) United States
(12) Patent Application Publication
(10) Pub. No.: US 2018/0077204 A1
(43) Pub. Date: Mar. 15, 2018

(54) INFORMATION PROCESSING TERMINAL, COMMUNICATION SYSTEM, INFORMATION PROCESSING METHOD, AND RECORDING MEDIUM

(71) Applicants: Takeru Inoue, Kanagawa (JP); Takeshi Koyama, Saitama (JP)

(72) Inventors: Takeru Inoue, Kanagawa (JP); Takeshi Koyama, Saitama (JP)

(21) Appl. No.: 15/706,278

(22) Filed: Sep. 15, 2017

(30) Foreign Application Priority Data
Sep. 15, 2016 (JP) 2016-180060
Mar. 17, 2017 (JP) 2017-052533
Jul. 20, 2017 (JP) 2017-141260

(51) Int. Cl. H04L 29/06

(52) U.S. Cl. CPC H04L 65/1069; H04L 65/403

(57) ABSTRACT

An information processing terminal: stores a counterpart list of one or more counterpart identifiers each representing a communication counterpart candidate of the information processing terminal; accepts a request destination identifier representing a counterpart information processing terminal, and participation authentication information; determines whether the request destination identifier matches any one of the counterpart identifiers; generates one of first communication start request information and second start request information, each request including the request destination identifier, the participation authentication information, and a request for communicating with the counterpart information processing terminal; and transmits the communication start request information to the communication management apparatus. When the request destination identifier matches the counterpart identifier, the circuitry generates the first start request information addressed to the communication management apparatus. When the request destination identifier does not match the counterpart identifier, the circuitry generates the second start request information addressed to the counterpart information processing terminal.

### CROSS-REFERENCE TO RELATED APPLICATIONS

This patent application is based on and claims priority pursuant to 35 U.S.C. § 119(a) to Japanese Patent Application No. 2016-180060, filed on Sep. 15, 2016, Japanese Patent Application No. 2017-052533, filed on Mar. 17, 2017, and Japanese Patent Application No. 2017-141260, filed on Jul. 20, 2017, in the Japan Patent Office, the entire disclosure of which is hereby incorporated by reference herein.

### BACKGROUND

### Technical Field

The present invention relates to an information processing terminal, a communication system, an information processing method, and a non-transitory recording medium.

### Description of the Related Art

In recent years, conference systems have been widely used to perform conferencing via a communication network such as the Internet. In such a conference system, the following method is known. A counterpart list indicating terminal information of terminals to be called (counterparts) is registered in advance in a terminal that performs a calling operation, and communication with a counterpart terminal selected from the counterpart list is started.

In the related art, in order to participate in a conference for restricted participants in a conference system, a user of a certain terminal first needs to connect to a terminal of another participant and needs to check the state of the terminal of the other participant and then needs to transmit information indicating participation authority. This operation has been burdensome.

### SUMMARY

Example embodiments of the present invention include an information processing terminal communicably connected with a communication management apparatus, which includes: a memory to store a counterpart list of one or more counterpart identifiers each representing a communication counterpart candidate of the information processing terminal, the one or more counterpart identifiers being associated with an identifier managed by the communication management apparatus; and circuitry to: accept a request destination identifier representing a counterpart information processing terminal that the information processing terminal requests for communication, and participation authentication information indicating that the information processing terminal has a participation authority to participate in communication with the counterpart communication terminal; determine whether the request destination identifier matches any one of the counterpart identifiers on the counterpart list; generate one of first communication start request information and second start request information according to a determination, each communication start request including the request destination identifier, the participation authentication information, and a request for communicating with the counterpart information processing terminal; and transmit the communication start request information to the communication management apparatus. Based on the determination indicating that the request destination identifier matches any one of the counterpart identifiers on the counterpart list, the circuitry generates the first start request information addressed to the communication management apparatus. Based on the determination indicating that the request destination identifier does not match any one of the counterpart identifiers on the counterpart list, the circuitry generates the second start request information addressed to the counterpart information processing terminal identified with the request destination identifier.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a communication system according to an embodiment;

FIG. 2 is an illustration of a state in which image data, sound data, and various kinds of management data are transmitted and received in the communication system, according to the embodiment;

FIG. 3 is an external view of an exemplary terminal according to an embodiment;

FIG. 4 is a diagram illustrating an exemplary hardware configuration of the terminal according to an embodiment;

FIG. 5 is a diagram illustrating an exemplary hardware configuration of a management system according to an embodiment;

FIG. 6 is a diagram illustrating functional configurations of the terminal and the management apparatus according to an embodiment;

FIGS. 7A and 7B (FIG. 7) are a diagram illustrating exemplary information managed by the management apparatus according to an embodiment;

FIGS. 8A and 8B (FIG. 8) are a diagram illustrating exemplary information managed by the management apparatus according to an embodiment;

FIG. 9 is a sequence diagram illustrating an exemplary preparatory process according to an embodiment:

FIG. 10 illustrates an exemplary screen on which a counterpart list is displayed;

FIG. 11 is a flowchart illustrating an operation of a request sender terminal according to a first embodiment;

FIGS. 12A and 12B illustrate start request information;

FIG. 13 is a sequence diagram illustrating an operation of the communication system according to the first embodiment;

FIGS. 14A and 14B (FIG. 14) are a sequence diagram illustrating a sequence of an operation of the communication system according to the first embodiment;

FIG. 15 is a flowchart illustrating an operation of the management apparatus according to the first embodiment;

FIG. 16 is a flowchart illustrating an operation of a request destination terminal according to the first embodiment;

FIG. 17 illustrates an exemplary screen for inputting an identifier;

FIG. 18 illustrates an exemplary screen for inputting participation authentication information;

FIG. 19 illustrates an exemplary screen by which a user is notified of a calling operation for a management apparatus;

FIG. 20 is a diagram illustrating an exemplary screen on which an error message is displayed;

FIG. 21 is a diagram illustrating an exemplary screen on which an error message is displayed;

FIG. 22 is a diagram illustrating an exemplary screen on which an error message is displayed;

FIG. 23 illustrates an exemplary screen by which a user is notified of connection to the request destination terminal;

FIG. 24 illustrates an exemplary screen by which a user is notified of an incoming call from a request sender terminal;

FIGS. 25A and 25B (FIG. 25) are a sequence diagram illustrating an operation of the communication system according to a second embodiment;

FIG. 26 is a flowchart illustrating an operation of the request sender terminal according to the second embodiment;

FIG. 27 is a diagram illustrating a functional configuration of a terminal according to a third embodiment;

FIGS. 28A and 28B (FIG. 28) are a sequence diagram illustrating an operation of the communication system according to the third embodiment;

FIGS. 29A and 29B (FIG. 29) are a sequence diagram illustrating an operation of the communication system according to the third embodiment; and

FIGS. 30A and 30B (FIG. 30) are a sequence diagram illustrating an operation of the communication system according to the third embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

### First Embodiment

Hereinafter, a first embodiment will be described with reference to some drawings.

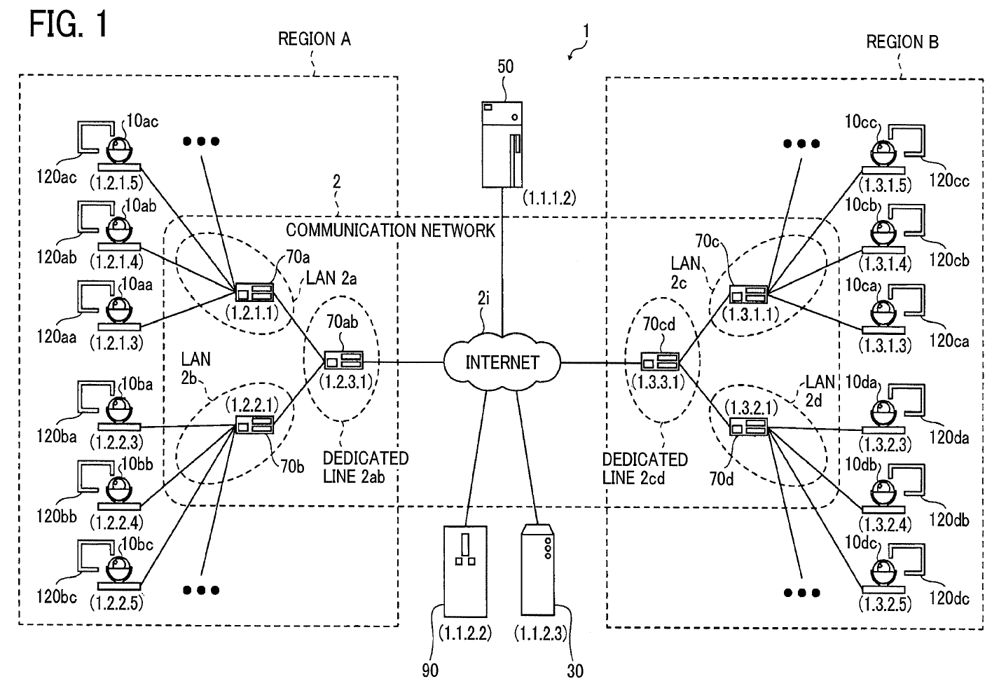

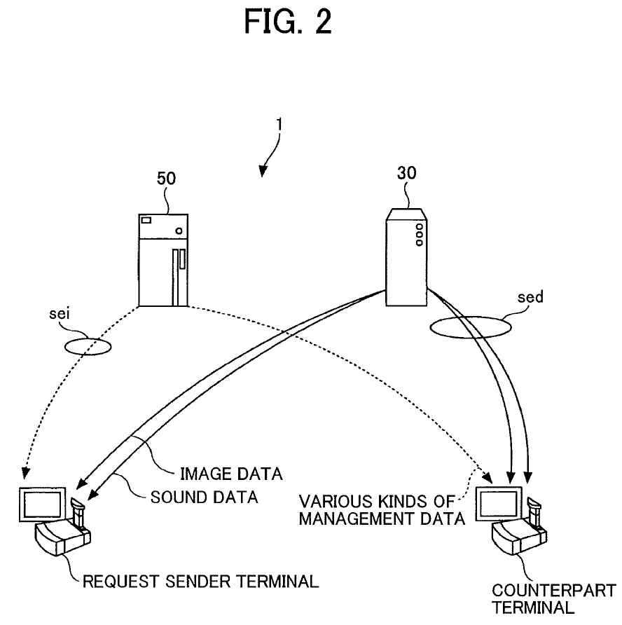

FIG. 1 schematically illustrates the communication system according to an embodiment. FIG. 2 is an illustration of a state in which image data, sound data, and various kinds of management data are transmitted and received in the communication system according to an embodiment.

The communication system includes a data providing system that transmits content data from a communication terminal to another communication terminal in one direction through a communication management system. The communication system also includes a communication system and the like in which information is mutually transmitted between a plurality of communication terminals through a communication management system.

This communication system is a system for mutually transmitting information between a plurality of communication terminals through a communication management system (corresponding to a “communication management apparatus”). Examples of the communication system include a videoconference system, a video telephone system, an audio conference system, an audio telephone system, a teleconference that uses a personal computer (PC) screen sharing system, and the like.

In this embodiment, a videoconference system, a videoconference management system, and a videoconference terminal are assumed as an exemplary communication system, an exemplary communication management system, and an exemplary communication terminal, respectively. Note that a videoconference is an exemplary teleconference.

Hereinafter, a communication system 1, a communication management system 50, and a communication terminal 10 will be described as the videoconference system, the videoconference management system, and the videoconference terminal, respectively. That is, the communication system according to this embodiment is applied to not only the videoconference system, but also another communication system or the like.

A communication system 1 illustrated in FIG. 1 includes a plurality of communication terminals (10aa, 10ab, . . . ), displays (120aa, 120ab, . . . ) for the respective communication terminals (10aa, 10ab, . . . ), a relay apparatus 30, a communication management system 50, a program providing apparatus 90, and the like. The plurality of communication terminals (10aa, 10ab, . . . ), for example, transmit and receive content data such as video data therebetween. Examples of the video data include moving image data, still image data, sound data, and the like.

Hereinafter, the “communication terminal” will simply be referred to as a “terminal”, and the “communication management system” will simply be referred to as a “management apparatus”. In addition, an arbitrary one or ones of the plurality of terminals (10aa, 10ab, . . . ) is/are referred to as a “terminal(s) 10”. Furthermore, an arbitrary one or ones of the plurality of displays (120aa, 120ab, . . . ) is/are referred to as a “display(s) 120”. Furthermore, a terminal serving as a request sender that requests the start of communication will be referred to as a “request sender terminal”, and a terminal serving as a request destination will be referred to as a “request destination terminal”. In addition, among request destination terminals, a request destination terminal included in a counterpart list, which will be described later, will be hereinafter referred to as a “counterpart terminal”. That is, the counterpart terminal is one of the request destination terminals.

As illustrated in FIG. 2, a management-data session sei used for transmitting and receiving various kinds of management data is established via the management apparatus 50 between the request sender terminal and the request destination terminal in the communication system 1. In addition, for example, an image-and-sound-data session sed (communication session) used for transmitting and receiving image data and sound data is also established via the relay apparatus 30 between the request sender terminal and the request destination terminal.

Referring back to FIG. 1, the system configuration of the communication system 1 will be further described.

Each terminal (information processing terminal) 10 transmits and receives various kinds of information to and from another terminal 10. The terminal 10, for example, establishes a communication session (image-and-sound-data session sed) with another terminal 10 and performs communication by transmitting and receiving content data including sound data, image data, and the like in the established communication session. This enables, for example, a videoconference between the plurality of terminals 10 in the communication system 1.

To start a videoconference in the communication system 1 according to an embodiment, a user who wishes to start a videoconference operates a certain terminal 10 so that the operated terminal 10 transmits start request information to the management apparatus 50.

The start request information herein is information for requesting the start of a session for the videoconference and includes information for designating a terminal 10 as a counterpart terminal of the session.

Note that the counterpart terminal (request destination terminal) may be a single terminal 10 or two or more terminals 10. That is, in the communication system 1, a videoconference can be enabled by using a session established between, not only two terminals 10, but also three or more terminals 10.

In addition, in the communication system 1 according to an embodiment, a user can participate in a videoconference for which a session has already been established and which has already been started. A user who wishes to participate in such a videoconference operates a certain terminal 10 so that the operated terminal 10 transmits to the management apparatus 50, participation request information designating the session that has already been established (hereinafter this session will be referred to as an established session) and used for the videoconference in which the user wishes to participate. Hereinafter, the terminal 10 that transmits the participation request information will be referred to as a “participation request terminal”.

The management apparatus 50 is a system including an information processing apparatus or a plurality of information processing apparatuses that integrally manage the terminals 10 and the relay apparatus 30. The management apparatus 50 establishes a communication session between the terminals 10 to enable a videoconference therebetween by communication.

Upon the start request information for a communication session being received from the request sender terminal, the management apparatus 50 establishes a communication session between the request sender terminal and the request destination terminal to start a videoconference. Upon the participation request information for an established session being received from the terminal 10, the management apparatus 50 causes the participation request terminal to participate in the established session.

A plurality of routers (70a, 70b, 70c, 70d, 70ab, and 70cd) illustrated in FIG. 1 each select an optimal path for content data. Hereinafter, an arbitrary one or ones of the routers (70a, 70b, 70c, 70d, 70ab, and 70cd) will be referred to as a “router(s) 70”.

The relay apparatus 30 relays content data between the plurality of terminals 10 under control of the management apparatus 50.

The program providing apparatus 90 includes a hard disk (HD), which will be described later, on which a terminal program is recorded for allowing each terminal 10 to implement a variety of functions and a variety of units, and the terminal program can be transmitted to the terminal 10.

The HD of the program providing apparatus 90 also stores a relay-apparatus program for allowing the relay apparatus 30 to implement a variety of functions and a variety of units, and the relay-apparatus program can be transmitted to the relay apparatus 30.

The HD of the program providing apparatus 90 further stores a communication-management program for allowing the management apparatus 50 to implement a variety of functions and a variety of units, and the communication-management program can be transmitted to the management apparatus 50.

The terminals (10aa, 10ab, 10ac, . . . ) are connected to the router 70a via a local area network (LAN) 2a so that communication can be performed. The terminals (10ba, 10bb, 10bc, . . . ) are connected to the router 70b via a LAN 2b so that communication can be performed. The LAN 2a and the LAN 2b are connected to each other via a dedicated line 2ab including the router 70ab and are configured within a region A so that communication can be performed. For example, the region A is Japan, the LAN 2a is configured within an office in Tokyo, and the LAN 2b is configured within an office in Osaka.

In addition, the terminals (10ca, 10cb, 10cc, . . . ) are connected to the router 70c via a LAN 2c so that communication can be performed. The terminals (10da, 10db, 10dc, . . . ) are connected to the router 70d via a LAN 2d so that communication can be performed. The LAN 2c and LAN 2d are connected to each other via a dedicated line 2cd including the router 70cd and are configured within a region B so that communication can be performed. For example, the region B is the United States, the LAN 2c is configured within an office in New York, and the LAN 2d is configured within an office in Washington D.C. The region A and the region B are connected to each other via an internet 2i from the routers (70ab and 70cd), respectively, so that communication can be performed.

The management apparatus 50, the program providing apparatus 90, and the relay apparatus 30 are connected to the terminals 10 via the internet 2i so that communication can be performed. The management apparatus 50, the program providing apparatus 90, and the relay apparatus 30 may be installed in the region A or the region B, or may be installed in any other region.

In the example illustrated in FIG. 1, a communication network 2 includes the LAN 2a, the LAN 2b, the dedicated line tab, the internet 2i, the dedicated line 2cd, the LAN 2c, and the LAN 2d. In the communication network 2, not only wired communication, but also wireless communication may be performed locally.

In the example illustrated in FIG. 1, each set of four digits below or above each of the terminals 10, the relay apparatus 30, the management apparatus 50, each of the routers 70, and the program providing apparatus 90 represents an internet protocol (IP) address in the typical Internet Protocol version 4 (IPv4) in a simple format. For example, the IP address of the terminal 10aa is “1.2.1.3”. Although IPv6 may be used instead of IPv4, description will be given by using IPv4 for simplicity.

Hardware Configuration

Next, hardware configurations according to an embodiment will be described.

Appearance of Terminal

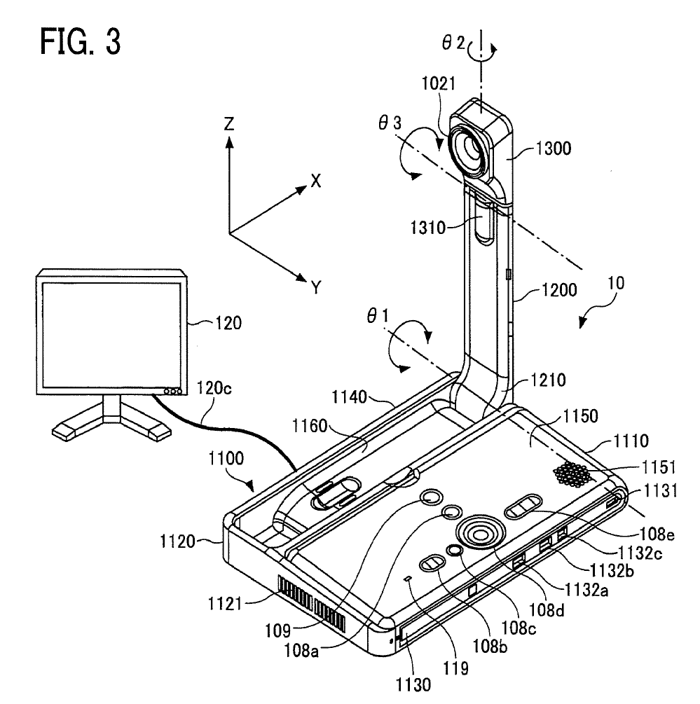

FIG. 3 is an external view of an exemplary terminal according to an embodiment. Hereinafter, the longitudinal direction of the terminal 10 will be referred to as the x-axis direction, the direction that intersects with the x-axis direction on a horizontal plane will be referred to as the y-axis direction, and the direction that intersects with the x-axis direction and the y-axis direction will be referred to as the z-axis direction (vertical direction).

As illustrated in FIG. 3, the terminal 10 includes a housing 1100, an arm 1200, and a camera housing 1300. Among these portions, a front wall 1110 of the housing 1100 has an inlet face including a plurality of inlet holes, and a rear wall 1120 of the housing 1100 has an exhaust face 1121 including a plurality of exhaust holes.

Thus, when a cooling fan that is built in the housing 1100 is driven, an air in front of the terminal 10 is taken in through the inlet face to be exhausted to the rear of the terminal 10 through the exhaust face 1121. On a right wall 1130 of the housing 1100, a sound collecting hole 1131 is formed, and a built-in microphone 114, which will be described later, can collect sounds such as voice, noise, and the like.

An operation panel 1150 is formed toward the right wall 1130 of the housing 1100. The operation panel 1150 includes a plurality of operation keys (108a to 108e), a power switch 109, and an alarm lamp 119, all of which will be described later. Further, on the operation panel 1150, a sound output face 1151 is formed with a plurality of voice output holes for transmitting sound that is output from a built-in speaker 115, which will be described later. A container 1160 for containing the arm 1200 and the camera housing 1300 is formed as a recess toward a left wall 1140 of the housing 1100. The right wall 1130 of the housing 1100 further has a plurality of connection ports (1132a to 1132c) for electrically connecting cables to an external apparatus connection interface (I/F) 118, which will be described later. On the other hand, the left wall 1140 of the housing 1100 has a connection port for electrically connecting a cable 120c for the display 120 to the external apparatus connection I/F 118, which will be described later.

Hereinafter, an arbitrary one or ones of the operation keys (108a to 108e) will be referred to as an “operation key(s) 108”, and an arbitrary one or ones of the connection ports (1132a to 1132c) will be referred to as a “connection port(s) 1132”.

The arm 1200 is coupled to the housing 1100 via a torque hinge 1210 to be rotatable in the vertical direction within a range of a tilt angle θ1 of 135 degrees with respect to the housing 1100. FIG. 3 illustrates a state in which the tilt angle θ1 is 90 degrees.

The camera housing 1300 includes a built-in camera 112, which will be described later, by which images of a user, document, room, and the like can be captured. A torque hinge 1310 is formed for the camera housing 1300, and the camera housing 1300 is coupled to the arm 1200 via the torque hinge 1310 to be rotatable in the vertical and horizontal directions within a range of a pan angle θ2 of ±180 degrees and a tilt angle θ3 of ±45 degrees, and FIG. 3 illustrates a state of 0 degrees.

As another example, the terminal 10 may be an information terminal such as a typical general computer, a tablet terminal, or a smartphone. To use an information terminal that is not equipped with a microphone or a camera as the terminal 10, an external microphone or camera is connected to the computer. Thus, the information terminal can be used as the terminal 10 according to an embodiment.

To use an information terminal as the terminal 10, an application for executing the process of the terminal 10, which will be described later, is installed in the information terminal. Accordingly, the terminal 10 is also referred to as an information processing terminal including the terminal illustrated in FIG. 3 and a typical information terminal.

Note that each of the relay apparatus 30, the management apparatus 50, and the program providing apparatus 90 has the same appearance as a typical server computer, and therefore description thereof will be omitted.

Hardware Configuration of Terminal

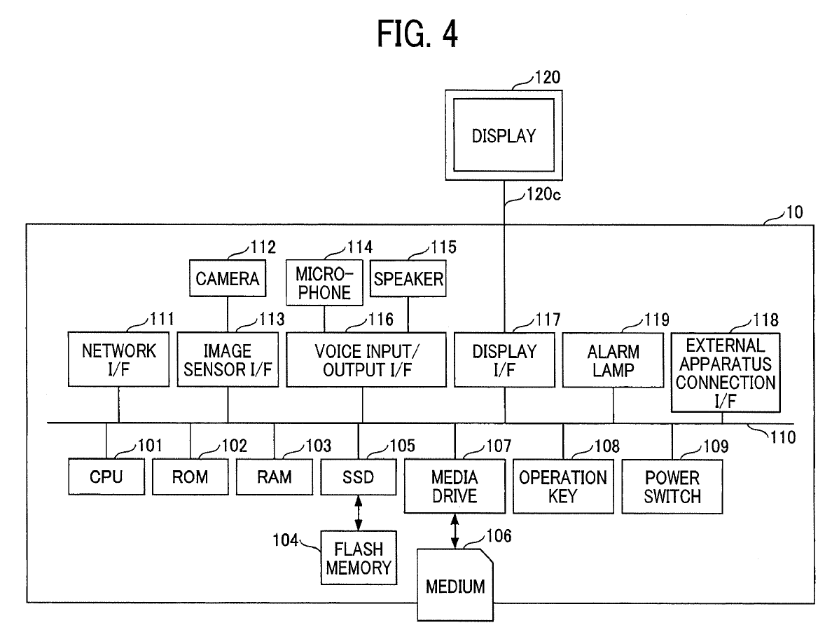

FIG. 4 illustrates an exemplary hardware configuration of the terminal 10 according to an embodiment. The terminal 10 has a typical computer configuration including, for example, a central processing unit (CPU) 101, a read only memory (ROM) 102, a random access memory (RAM) 103, a flash memory 104, and a solid state drive (SSD) 105. The terminal 10 further includes a media drive 107, the operation key(s) 108, the power switch 109, a network I/F 111, the camera 112, an image sensor I/F 113, the microphone 114, the speaker 115, and a sound input/output I/F 116. The terminal 10 further includes a display I/F 117, the external apparatus connection I/F 118, the alarm lamp 119, a bus 110, and the like.

The CPU 101 is, for example, a processor that reads programs and data from the ROM 102, the flash memory 104, and the like and performs processes to implement the functions of the terminal 10. The ROM 102 is, for example, a non-volatile memory that stores in advance programs and the like used to start the CPU 101, such as an initial program loader (IPL). The RAM 103 is a volatile memory used as a work area and the like of the CPU 101.

The flash memory 104 is, for example, a storage device that stores an operating system (OS), an application program, various kinds of data, and the like. The SSD 105 controls reading and writing of various kinds of data from and to the flash memory 104 under control of the CPU 101. The media drive 107, for example, controls reading and writing (storing) of data from and to a recording medium 106 such as a memory card.

Each of the operation keys 108 is an input device that receives an input operation performed by a user of the terminal 10. The power switch 109 is a switch for switching on and off the power of the terminal 10. The network I/F 111 is a communication interface for communicating by using the communication network 2.

The camera 112 is an image capturing device for capturing images of a subject under control of the CPU 101. The image sensor I/F 113 controls image capturing performed by the camera 112 and converts data obtained through image capturing into predetermined image data (video data). The microphone 114 converts voice that has been collected into an electrical signal. The speaker 115 converts the voice signal into voice and outputs the voice. The sound input/output I/F 116 controls input and output of voice by using the microphone 114 and the speaker 115.

The display I/F 117 transmits image data to the display 120 under control of the CPU 101. The external apparatus connection I/F 118 is an interface for connecting a variety of external apparatuses. The alarm lamp 119 is a light emitting device for notifying a user in case of an abnormality in various functions of the terminal 10. The bus 110 is connected to each of the above components, and an address signal, a data signal, a variety of control signals, and the like are transmitted therethrough.

The display 120 is a display unit formed of a liquid crystal panel or an organic electroluminescent (EL) panel on which an image of a subject, an operation icon, and the like are displayed. In addition, the display 120 is connected to the display I/F 117 via the cable 120c.

The camera 112 includes a lens and a solid-state image sensor that converts light into electric charge to digitize an image (video) of a subject. Examples of the solid-state image sensor include a complementary metal oxide semiconductor (CMOS) sensor, a charge coupled device (CCD), and the like.

The external apparatus connection IN 118 can be electrically connected to an external apparatus such as an external camera, an external microphone, or an external speaker via a Universal Serial Bus (USB) cable or the like inserted into the connection port 1132 of the housing 1100 illustrated in FIG. 3.

If an external camera is connected, the external camera is driven preferentially to the built-in camera 112 under control of the CPU 101. Likewise, if an external microphone is connected or an external speaker is connected, the external microphone or the external speaker is driven preferentially to the built-in microphone 114 or the built-in speaker 115, respectively, under control of the CPU 101.

The recording medium 106 is detachable from the terminal 10. Not only the flash memory 104, any non-volatile memory from or to which data is read or written under control of the CPU 101 may be used, such as an electrically erasable and programmable ROM (EEPROM).

The above-described terminal program may be recorded in a file in an installable format or an executable format on a computer-readable recording medium (e.g., the recording medium 106) to be circulated. In addition, the above-described terminal program may be stored in the ROM 102 instead of the flash memory 104.

Hardware Configuration of Management Apparatus

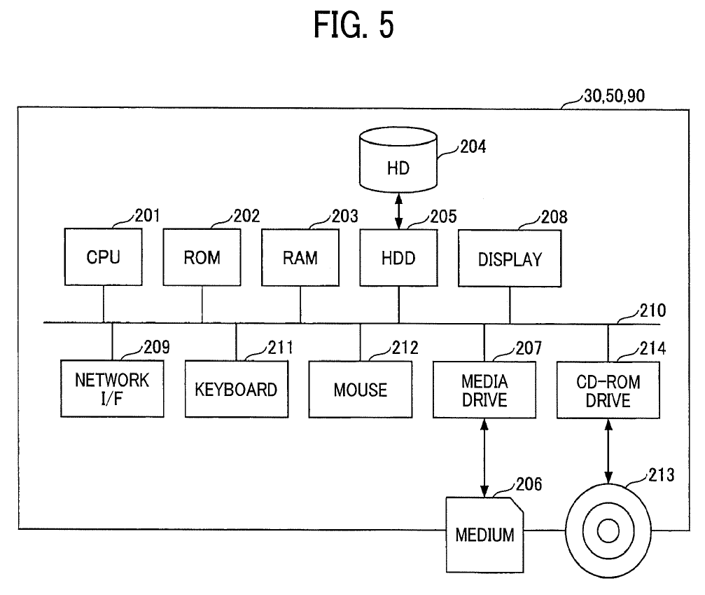

FIG. 5 illustrates a hardware configuration of the management apparatus 50 according to an embodiment. The management apparatus 50 has a typical computer hardware configuration including, for example, a CPU 201, a ROM 202, a RAM 203, an HD 204, a hard disk drive (HDD) 205, a media drive 207, a display 208, and the like. The management apparatus 50 further includes a network I/F 209, a keyboard 211, a mouse 212, a compact disc (CD)-ROM drive 214, a bus 210, and the like.

The CPU 201 is, for example, a processor that reads programs and data from the ROM 202, the HD 204, and the like and performs processes to implement the functions of the management apparatus 50. The ROM 202 is, for example, a non-volatile memory that stores in advance programs and the like used to start the CPU 201, such as an IPL. The RAM 203 is a volatile memory used as a work area and the like of the CPU 201.

The HD 204 is, for example, a storage device that stores an OS, a program such as an application program, and various kinds of data. The HDD 205 controls reading and writing of various kinds of data from and to the HD 204 under control of the CPU 201. The display 208 is a display device on which various kinds of information such as a cursor, a menu, a window, a character, and an image are displayed.

The network I/F 209 is a communication interface for performing data communication by using the communication network 2. The keyboard 211 is an exemplary input device for accepting an input operation of a character, a numeric value, various instructions, and the like performed by a user. The mouse 212 is an exemplary pointing device for accepting an operation for selecting and executing various instructions, selecting a process target, or moving a cursor, performed by a user.

The media drive 207 controls, for example, reading and writing (storing) of data from and to a recording medium 206 such as a memory card. The CD-ROM drive 214 controls reading and writing of data from and to a CD-ROM 213 of any kind as an exemplary detachable recording medium. The bus 210 electrically connects each of the above components, and an address signal, a data signal, a variety of control signals, and the like are transmitted therethrough.

Note that the above-described hardware configuration of the management apparatus 50 is merely an example. For example, the display 208, the keyboard 211, the mouse 212, and the like may be externally connected to the management apparatus 50.

The above-described program for the management apparatus 50 may be recorded in a file in an installable format or an executable format on a computer-readable recording medium such as the recording medium 206 or the CD-ROM 213 to be circulated. In addition, the above-described program for the management apparatus 50 may be stored in the HD 204 or may be stored in advance in the ROM 202.

The relay apparatus 30 has substantially the same hardware configuration as the above-described management apparatus 50, and therefore description thereof will be omitted. Note that a program for the relay apparatus 30 for controlling the relay apparatus 30 is recorded on the HD 204. Also in this case, the program for the relay apparatus 30 may be recorded in a file in an installable format or an executable format on a computer-readable recording medium such as the recording medium 206 or the CD-ROM 213 to be circulated.

The program providing apparatus 90 also has substantially the same hardware configuration as the above-described management apparatus 50, and therefore description thereof will be omitted. Note that a program for providing a program for controlling the program providing apparatus 90 is recorded on the HD 204. Also in this case, the program for providing a program may be recorded in a file in an installable format or an executable format on a computer-readable recording medium such as the recording medium 206 or the CD-ROM 213 to be circulated.

As another example of the detachable recording medium, a computer-readable recording medium such as a compact disc recordable (CD-R), a digital versatile disk (DVD), or a Blu-ray Disc may be used to record and provide a program.

Functional Configurations

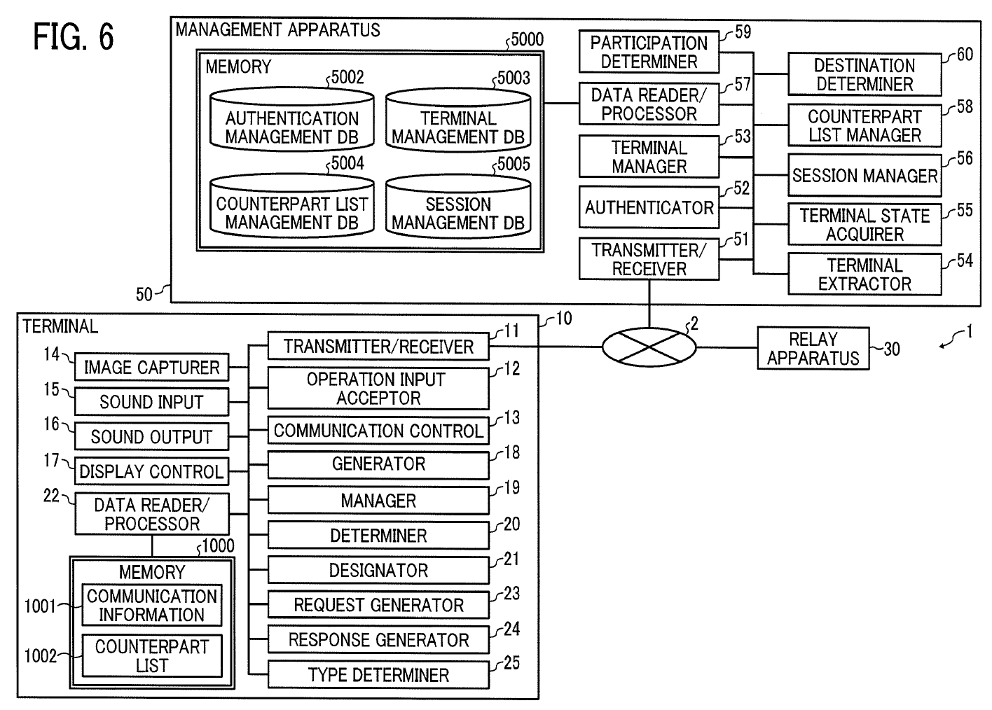

FIG. 6 illustrates functional configurations of the terminal 10 and the management apparatus 50 according to an embodiment. As illustrated in FIG. 6, the terminal 10, the relay apparatus 30, and the management apparatus 50 are connected to one another via the communication network 2 so that communication can be performed. Note that the program providing apparatus 90 illustrated in FIG. 1 is omitted from FIG. 6 because it is not directly relevant to communication according to an embodiment.

First, functions of the terminal 10 will be described.

The terminal 10 includes a data transmitter/receiver 11, an operation input acceptor 12, a communication control 13, an image capturer 14, a sound input 15, a sound output 16, a display control 17, a generator 18, a manager 19, a determiner 20, a designator 21, and a data reader/processor 22, a request generator 23, a response generator 24, and a type determiner 25. Each of the above functions is implemented by a terminal control program (information processing program) that is loaded from the flash memory 104 to the RAM 103 and executed by the CPU 101. In addition, the terminal 10 further includes a memory 1000 configured by the RAM 103, the flash memory 104, and the like.

The data transmitter/receiver 11 is implemented by, for example, a program executed by the CPU 101 illustrated in FIG. 4, the network I/F 111 illustrated in FIG. 4, and the like and transmits and receives various kinds of data, information, and the like to and from another terminal 10, an apparatus, or a system via the communication network 2. For example, the data transmitter/receiver 11 serves as a receiver that receives from the management apparatus 50, request destination terminal information indicating a terminal 10 that serves as a request destination terminal and state information indicating the operating state and the like of the request destination terminal.

Before starting a videoconference with a request destination terminal, the data transmitter/receiver 11 according to this embodiment starts to receive from the management apparatus 50, state information representing the state of each terminal 10 (request destination terminal) that may serve as a connection destination for a videoconference. The state information may represent not only the operating state of each terminal 10 as to whether the terminal 10 is online or offline but also the operating state as to whether the terminal 10 is online and capable of communicating or is online and currently communicating, or the like. The state information may further include, for example, a session ID that is an identifier for identifying a communication session in which each terminal 10 participates. The state information may further indicate various states such as a state in which the cable 120c is detached from a terminal 10, a state in which a terminal 10 is capable of outputting sound but is incapable of outputting an image, and a state in which a terminal 10 is set so as not to output sound (mute).

The operation input acceptor 12 is implemented by, for example, a program executed by the CPU 101 illustrated in FIG. 4, the operation key(s) 108 and the power switch 109 illustrated in FIG. 4, and the like and accepts various input operations performed by a user. For example, if a user switches on the power switch 109 illustrated in FIG. 4, the operation input acceptor 12 illustrated in FIG. 6 accepts the power on operation, and the power is controlled to be switched on. In addition, the operation input acceptor 12 accepts a request destination selection operation and the like performed on a request destination selection screen through, for example, depressing or the like of the operation key(s) 108.

The communication control 13 is implemented by, for example, a program executed by the CPU 101 illustrated in FIG. 4. For example, in response to acceptance of the above power on operation, the communication control 13 automatically transmits the current IP address of the request sender terminal from the data transmitter/receiver 11 to the management apparatus 50 via the communication network 2. The communication control 13 also transmits to the management apparatus 50, login request information for requesting login.

In addition, if a user switches off the power switch 109 from the state in which the power was on, the data transmitter/receiver 11 transmits to the management apparatus 50, state information for switching off the power. Subsequently, the operation input acceptor 12 switches off the power. Thus, the management apparatus 50 can acquire the information that the terminal 10 has been switched off from the state in which the power was on.

In addition, the communication control 13 controls communication in various manners, such as establishing and ending a communication session in which content data is transmitted and received to and from another terminal 10 through the relay apparatus 30.

The image capturer 14 is implemented by, for example, a program executed by the CPU 101 illustrated in FIG. 4, the camera 112 and the image sensor I/F 113 illustrated in FIG. 4, and the like and captures an image of a subject and outputs image data obtained by capturing the image.

The sound input 15 is implemented by, for example, a program executed by the CPU 101 illustrated in FIG. 4, the sound input/output I/F 116 illustrated in FIG. 4, and the like and inputs sound data related to a voice signal that has been obtained by conversion of a voice of a user performed by the microphone 114.

The sound output 16 is implemented by, for example, a program executed by the CPU 101 illustrated in FIG. 4, the sound input/output I/F 116 illustrated in FIG. 4, and the like and outputs a voice signal related to sound data to the speaker 115 to output the sound from the speaker 115.

The display control 17 is implemented by, for example, a program executed by the CPU 101 illustrated in FIG. 4, the display I/F 117 illustrated in FIG. 4, and the like and causes image data to be displayed on the display 120. For example, the display control 17 causes a counterpart list used for selecting a communication counterpart, to be displayed on a display unit such as the display 120.

The display control 17 according to this embodiment causes the counterpart list to be displayed on the display unit in cooperation with the generator 18, the manager 19, the determiner 20, and the like, which will be described later. For example, if the determiner 20 determines that communication with a communication counterpart has abnormally ended, the display control 17 causes a counterpart list 1002 generated by the generator 18 to be displayed on the display unit, by using the terminal information of the communication counterpart terminal managed by the manager 19, so that a user can designate the terminal with which communication has been performed. A specific display control method executed by the display control 17 to display the counterpart list will be described later.

The generator 18 is implemented by, for example, a program executed by the CPU 101 illustrated in FIG. 4. The generator 18, for example, generates and updates, by using the request destination terminal information and state information received by the data transmitter/receiver 11 from the management apparatus 50, a counterpart list indicating the identifier of one of the request destination terminals as a choice of a communication counterpart. That is, a counterpart terminal is a terminal that is set as a choice of a communication counterpart in the counterpart list among the request destination terminals.

The counterpart list preferably includes information (e.g., the terminal name or the address name) of the counterpart terminal, information indicating the operating state of the counterpart terminal (e.g., an icon indicating the state of the counterpart terminal), and the like.

The manager 19 is implemented by, for example, a program executed by the CPU 101 illustrated in FIG. 4. The manager 19 causes information (e.g., an identifier for identifying a terminal) of another terminal 10 with which the terminal 10 communicates, to be stored in communication information 1001 in the memory 1000 and manages the information.

The manager 19 preferably manages the identifiers of other terminals 10 with which the terminal 10 communicates, in association with priorities. Thus, even if the terminal 10 communicates with a plurality of terminals 10, it is possible to designate one of the terminals 10 having the highest priority. Hereinafter, the identifier of each terminal 10 will be simply referred to as an “identifier”. Note that the identifier includes a terminal ID for identifying a terminal 10, a user ID for identifying a user, and the like.

The manager 19 preferably manages the identifier(s) of one or more terminals 10 with which the terminal 10 communicates (or has communicated), information indicating the priority of each terminal, and a session ID for identifying a session for a teleconference in which the terminal 10 is participating (or has participated), in association with one another. Thus, it is possible to designate one of the terminals 10 having the highest priority excluding, for example, a terminal participating in another session.

The determiner 20 is implemented by, for example, a program executed by the CPU 101 illustrated in FIG. 4 and determines, if communication with another terminal 10 has been ended, whether ending communication is normal or abnormal.

The determiner 20 preferably determines that ending communication is normal if communication has been ended by a user operation on the terminal 10. In addition, the determiner 20 determines that ending communication is abnormal if communication has been ended for a reason other than a user operation on the terminal 10. Note that examples of the reason other than a user operation include abnormality in the communication network 2, the terminal 10 serving as a communication counterpart, the relay apparatus 30, the router(s) 70, the management apparatus 50, and the like.

Alternatively, for example, the determiner 20 may determine whether ending communication is normal or abnormal on the basis of, for example, a reason for ending communication that is transmitted from the data transmitter/receiver 11 or the communication control 13 when communication is ended. For example, if the reason for ending communication transmitted from the communication control 13 (or the data transmitter/receiver 11) is normal (or if there is no reason for ending communication), the determiner 20 may determine that ending communication is normal. If the reason for ending communication transmitted from the communication control 13 (or the data transmitter/receiver 11) includes a reason for ending communication other than a normal ending (e.g., degradation in communication quality or a timeout), the determiner 20 may determine that ending communication is abnormal, for example.

The designator 21 is implemented by, for example, a program executed by the CPU 101 illustrated in FIG. 4. For example, in accordance with whether ending communication with another terminal 10 is normal or abnormal, the designator 21 designates a counterpart for which a display component is to be displayed in the counterpart list displayed by the display control 17, and the display component indicates that the counterpart is selected as a communication request destination. For example, when the communication with another terminal 10 is ended, in accordance with whether ending communication with the other terminal 10 is normal or abnormal, the designator 21 designates a counterpart to receive focus in the counterpart list displayed by the display control 17.

Note that the focus represents a state in which, for example, a display component or the like is selectable on an operation screen of a computer or the like. In this embodiment, “receiving focus” means displaying a counterpart, selected as a communication request destination from the counterpart list displayed by the display control 17, in a distinguishable manner by using a display component such as a bold frame or a cursor, or highlighting. In addition, “displaying in a distinguishable manner” means displaying the accepted identifier in such a manner that it is understood that the identifier is included in the list. Thus, for example, the identifier itself may be displayed to be distinguishable, or a message such as “included in list” may be displayed to be distinguishable.

Thus, if a user's calling operation as an instruction for starting communication is accepted, the terminal 10 starts a calling process for a counterpart that receives focus in the counterpart list. Note that the focus is an exemplary method for displaying a terminal in such a manner that the terminal can be distinguished as being selected as a communication request destination in the counterpart list.

The data reader/processor 22 is implemented by a program executed by the CPU 101 illustrated in FIG. 4, the SSD 105 illustrated in FIG. 4, and the like and performs processing of causing various kinds of data to be stored in the memory 1000, reading the various kinds of data from the memory 1000, and the like.

In response to an input operation being accepted by the operation input acceptor 12, the request generator 23 generates start request information for starting a session and participation request information for participating in a session, for the terminal 10. More specifically, if a start request is to be transmitted to the management apparatus 50, the request generator 23 generates start request information destined for the management apparatus 50. In addition, if a start request is to be transmitted to a request destination terminal, the request generator 23 generates start request information destined for the request destination terminal. Details of the request generator 23 and the start request information will be described later.

The response generator 24 generates a response when a start request, a participation request, or the like is accepted from another terminal 10. The type determiner 25 determines whether the type of a session is a restricted type on the basis of a request destination terminal, start instruction information or the like from the management apparatus 50, or the like. Details of processing performed by the response generator 24 and the type determiner 25 will be described later.

The memory 1000 is implemented by, for example, the flash memory 104 and the RAM 103 illustrated in FIG. 4, a program executed by the CPU 101 illustrated in FIG. 4, and the like and stores, for example, information such as an identifier for identifying the terminal 10 and a password.

In addition, the memory 1000 is also used as, for example, a reception buffer of image data and sound data received when a videoconference with the request destination terminal is performed.

Next, functions of the management apparatus 50 will be described.

The management apparatus 50 includes a data transmitter/receiver 51, an authenticator 52, a terminal manager 53, a terminal extractor 54, a terminal state acquirer 55, a session manager 56, a data reader/processor 57, a counterpart list manager 58, a participation determiner 59, and a destination determiner 60. Each of the above functions is implemented in accordance with a communication-management program that is loaded from the HD 204 to the RAM 203 and executed by the CPU 201. In addition, the management apparatus 50 further includes a memory 5000 configured by the HD 204 and the like.

Now, information stored in the memory 5000 and managed by the management apparatus 50 will be described. The memory 5000 stores an authentication management database (DB) 5002, a terminal management DB 5003, a counterpart list management DB 5004, and a session management DB 5005. Each of the databases stored in the memory 5000 according to this embodiment may be provided in advance in the memory 5000.

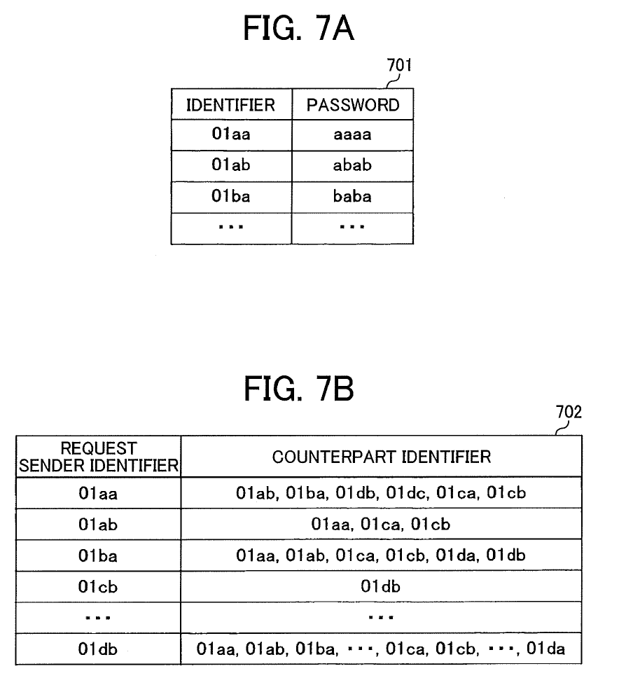

FIGS. 7A and 7B are first diagrams illustrating exemplary information managed by the management apparatus 50 according to an embodiment.

FIG. 7A illustrates an exemplary authentication management table, and FIG. 7B illustrates an exemplary counterpart list management table.

In the memory 5000, for example, the authentication management DB 5002 including an authentication management table 701 illustrated in FIG. 7A is configured. In the authentication management table 701, identifiers for identifying the respective terminals 10 managed by the management apparatus 50 are managed in association with the respective passwords. For example, the authentication management table 701 illustrated in FIG. 7A indicates that the password corresponding to an identifier “01aa” is “aaaa”.

FIG. 7B illustrates an exemplary counterpart list management table. In the memory 5000, for example, the counterpart list management DB 5004 including a counterpart list management table 702 illustrated in FIG. 7B is configured. In the counterpart list management table 702, request sender identifiers that are identifiers used for request sender terminals are managed in association with counterpart identifiers that are identifiers used for counterpart terminals. Here, each request sender terminal is a terminal 10 serving as a sender of request information for requesting the start of communication for a videoconference.

In addition, a counterpart terminal is a request destination terminal for which an identifier has been registered in the counterpart list management table 702 among request destination terminals that can be set as the destination to which the request sender terminal can transmit the request information.

For example, the example illustrated in FIG. 7B indicates that request destination terminals to which the terminal 10 whose identifier is “01aa” can request the start of a videoconference are terminals 10 whose identifiers are “01ab”, “01ba”, “01db”, “01dc”, “01ca”, and “01cb”. A request destination terminal is, for example, added or deleted in accordance with a request from the terminal 10 to the management apparatus 50.

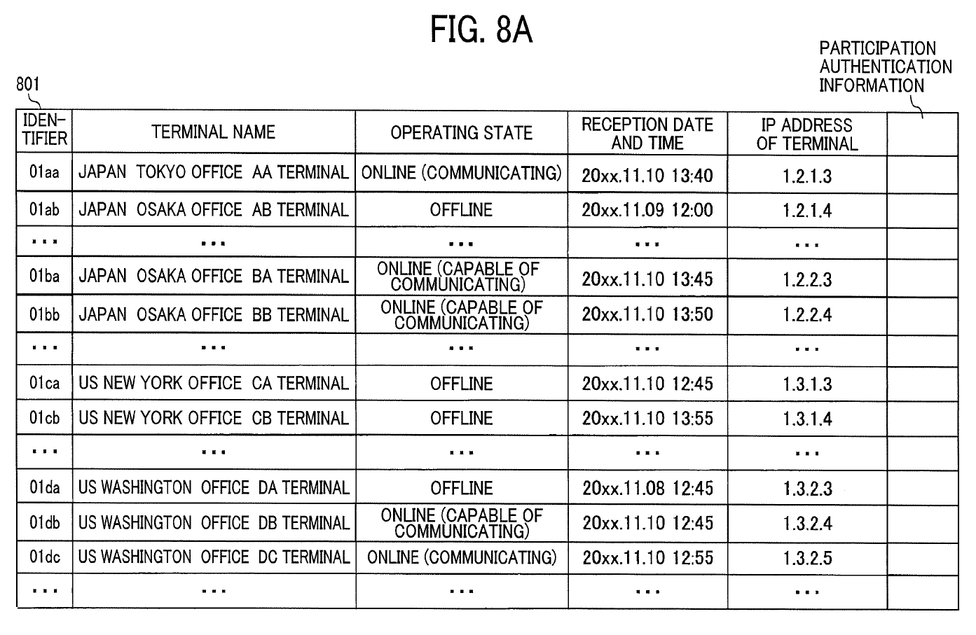

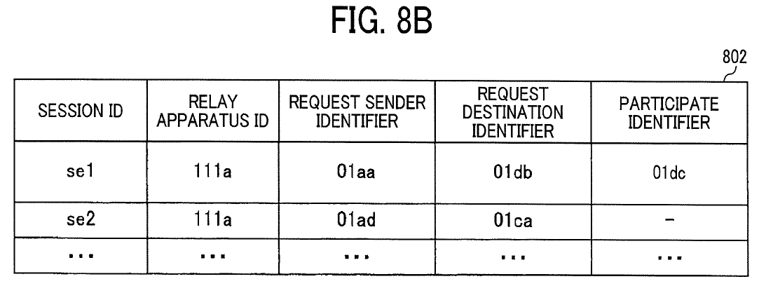

FIGS. 8A and 8B are second diagrams illustrating exemplary information managed by the management apparatus 50 according to an embodiment.

FIG. 8A illustrates an exemplary terminal management table, and FIG. 8B illustrates an exemplary session management table. In the memory 5000, for example, the terminal management DB 5003 including a terminal management table 801 illustrated in FIG. 8A is configured.

In the terminal management table 801, the names (hereinafter referred to as “terminal names”) of request destination terminals of the respective terminals 10, the operating states of the terminals 10, the reception date and time, the IP addresses of the terminals 10, and participation authentication information are managed in association with one another according to the identifier of each terminal 10. The reception date and time represents the date and time at which the management apparatus 50 received login request information for logging in to the communication system 1. The participation authentication information may be generated at the management apparatus 50 and transmitted to the terminal 10, for example, when the terminal 10 logs into the management apparatus 50 to establish a session.

For example, the terminal management table 801 illustrated in FIG. 8A indicates that a terminal 10 whose identifier is “01aa” has a terminal name “Japan, Tokyo Office, Terminal AA” has the operating state “online (communicating)”. In addition, the terminal management table 801 also indicates that the date and time at which the management apparatus 50 received login request information is “20xx, November 10, 13:40” and that the IP address of the terminal 10 is “1.2.1.3”.

Here, the identifier in the terminal management table 801 is uniquely assigned when a terminal 10 is registered in the communication system 1, and the terminal name is registered or changed by an administrator of the management apparatus 50. Note that the terminal name may be registered or changed in accordance with a request from a terminal 10 to the management apparatus 50.

In addition, the operating state “online (capable of communicating)” indicates a state in which the terminal 10 has logged into the communication system 1 and is not participating in a videoconference. The operating state “online (communicating)” indicates a state in which the terminal 10 has logged into the communication system 1 and is currently participating in a videoconference. The operating state “offline” indicates a state in which the terminal 10 has not logged into the communication system 1.

The participation authentication information is information for authenticating participation in a session for restricted participants. In other words, the participation authentication information is information indicating participation authority for participating in a session for restricted participants. In this embodiment, alphabetical characters, numerical characters, symbols, PIN codes obtained by combining digits, and the like are used for the participation authentication information. However, the participation authentication information is not limited to this example and may have any other format.

The session management DB 5005 stored in the memory 5000 of the management apparatus 50 includes, for example, a session management table 802 illustrated in FIG. 8B. In the session management table 802, information is stored, such as a relay apparatus ID that is an identifier for identifying the relay apparatus 30, request sender identifiers, request destination identifiers, and participant identifiers according to the session ID that is the identifier of a communication session.

Note that each request sender identifier is the identifier of a request sender terminal that requests the start of a communication session for a videoconference or the like, each request destination identifier is the identifier used for a request destination terminal. Each participant identifier is the identifier used for one or more participation request terminals that request participation in a communication session (established session) for, for example, an active videoconference.

In this embodiment, the request destination identifier includes both a counterpart identifier that is registered in the counterpart list management table 702 and a request destination identifier that is not registered in the counterpart list management table 702.

For example, the session management table 802 illustrated in FIG. 8B indicates that a terminal whose identifier is “01aa”, a terminal whose identifier is “01db”, and a terminal whose identifier is “01 dc” are participating in a session whose session ID is “se1”.

Referring back to FIG. 6, the functional configuration of the management apparatus 50 will be further described.

The data transmitter/receiver 51 is implemented by, for example, the network I/F 209 illustrated in FIG. 5, a program executed by the CPU 201 illustrated in FIG. 5, and the like and transmits and receives various kinds of data and information to and from another terminal 10, the relay apparatus 30, and the program providing apparatus 90 via the communication network 2.

The data transmitter/receiver 51 transmits to the request sender terminal, a list of counterpart identifiers corresponding to each request sender identifier (hereinafter this list will be referred to as counterpart list information), and state information representing the operating states of the terminals using the counterpart identifiers included in the counterpart list information. Each time the operating state of a terminal serving as a request destination terminal is changed, the data transmitter/receiver 51 transmits the latest state information to the request sender terminal.

The authenticator 52 is implemented by, for example, a program executed by the CPU 201 illustrated in FIG. 5. The authenticator 52 searches the authentication management table 701 included in the authentication management DB 5002 in the memory 5000 by using, as search keys, an identifier and a password included in the login request information received through the data transmitter/receiver 51. In addition, the authenticator 52 determines whether the identifier and the password included in the login request information are managed in the authentication management DB 5002 to perform authentication of the terminal 10.

The terminal manager 53 is implemented by, for example, a program executed by the CPU 201 illustrated in FIG. 5. The terminal manager 53 manages the operating state of the request sender terminal, which has requested login. The terminal manager 53 stores and manages, for example, the operating state, the reception date and time at which the management apparatus 50 received the login request information, and the IP address in the terminal management table 801 included in the terminal management DB 5003 in association with the request sender identifier of the request sender terminal.

For example, if a user switches off the power switch 109 of the terminal 10 from the state in which the power was on, on the basis of the state information for switching off the power transmitted from the terminal 10, the terminal manager 53 changes the operating state of the terminal 10 in the terminal management table 801 from online to offline.

The terminal extractor 54 is implemented by, for example, a program executed by the CPU 201 illustrated in FIG. 5. The terminal extractor 54 searches the counterpart list management table 702 included in the counterpart list management DB 5004 by using, as a search key, the request sender identifier of the request sender terminal, which has requested login, and extracts a counterpart identifiers corresponding to the request sender identifier.

The terminal extractor 54 also searches the counterpart list management table 702 by using, as a search key, the request sender identifier of the request sender terminal, which has requested login, and extracts the request sender identifier of a different request sender terminal for which the request sender identifier has been registered as a counterpart identifier.

The terminal state acquirer 55 is implemented by, for example, a program executed by the CPU 201 illustrated in FIG. 5. The terminal state acquirer 55 searches the terminal management table 801 included in the terminal management DB 5003 by using, as search keys, the counterpart identifiers extracted by the terminal extractor 54 and reads, for each extracted counterpart identifier, the operating state of a terminal using the extracted identifier. In other words, the terminal state acquirer 55 reads from in the terminal management table 801, the operating state associated with the identifier that is the same as a counterpart identifier extracted by the terminal extractor 54.

Thus, the terminal state acquirer 55 can acquire the operating state of a terminal that serves as the request destination terminal of the request sender terminal, which has requested login. In addition, the terminal state acquirer 55 searches the terminal management DB 5003 by using the request sender identifier of the request sender terminal, which has requested login, as a search key and acquires the operating state of the request sender terminal, which has requested login.

The session manager 56 is implemented by, for example, a program executed by the CPU 201 illustrated in FIG. 5 and manages a communication session for a videoconference (exemplary teleconference) performed by the management apparatus 50. For example, the session manager 56 generates a session ID that is an identifier for identifying a communication session at the time of starting the communication session. In addition, the session manager 56 stores and manages information in the session management table 802 included in the session management DB 5005, such as the identifier of a terminal 10 that participates in the communication session and the relay apparatus ID of the relay apparatus 30, in association with the generated session ID.

The data reader/processor 57 is implemented by, for example, the HDD 205 illustrated in FIG. 5, a program executed by the CPU 201 illustrated in FIG. 5, and the like and, for example, causes various kinds of data to be stored in the memory 5000 and reads the various kinds of data from the memory 5000.

The counterpart list manager 58 causes the above-described counterpart list management table 702 illustrated in FIG. 7B to be stored in the counterpart list management DB 5004 and manages the counterpart list management table 702. The counterpart list manager 58 is implemented by, for example, a program executed by the CPU 201 illustrated in FIG. 5 and manages, for each request sender identifier, the counterpart list management table (counterpart list) 702 in which information (counterpart identifier) about one or more terminals 10 as a counterpart(s) in a conference (communication session) is stored.

If the data transmitter/receiver 51 receives a request for participating in an established session from a certain terminal 10, the participation determiner 59 determines whether a participation request terminal, which has transmitted the participation request information, is permitted to participate in the established session by referring to the participation authentication information corresponding to the established session. Note that the identifier used by the participation request terminal is a participation request identifier.

More specifically, if the participation request information represents a request for participating in an established session that has been established in response to start request information for starting a session for restricted participants, the participation determiner 59 compares the participation authentication information received from a start request terminal, which has requested the start of the session, with the participation authentication information received from the participation request terminal. Based on the comparison result, the participation determiner 59 permits the participation request terminal to participate in the established session or requests the participation request terminal to input the participation authentication information. That is, if the participation authentication information received from the start request terminal is the same as the participation authentication information received from the participation request terminal, the participation determiner 59 permits the participation request terminal to participate in the established session. In addition, if the participation request information represents a request for participating in an established session that has been established in response to start request information for starting a session for which participants are not restricted, the participation determiner 59 also permits the participation request terminal to participate in the established session.

If the participation authentication information received from the start request terminal is not the same as the participation authentication information received from the participation request terminal, the participation determiner 59 requests the participation request terminal to input the participation authentication information again without immediately refusing the participation request terminal to participate in the established session. Then, if the number of errors of the participation authentication information received from the start request terminal is not the same as the participation authentication information received from the participation request terminal reaches a predetermined upper limit, the participation determiner 59 refuses the participation request terminal to participate in the established session.

The destination determiner 60 determines whether the start request information is to be transferred to the request destination terminal based on, for example, the start request information transmitted from the terminal 10.

Next, the relay apparatus 30 will be described.

The relay apparatus 30 relays transmission and reception of content data between a plurality of terminals 10 in a videoconference performed between the terminals 10. For example, on the basis of the session ID that is transmitted from the management apparatus 50, the relay apparatus 30 causes a terminal 10 having the same session ID to participate in the same session. Thus, terminals 10 having the same session ID can transmit and receive content data through the relay apparatus 30.

Next, a process flow of communication performed by the communication system 1 will be described.

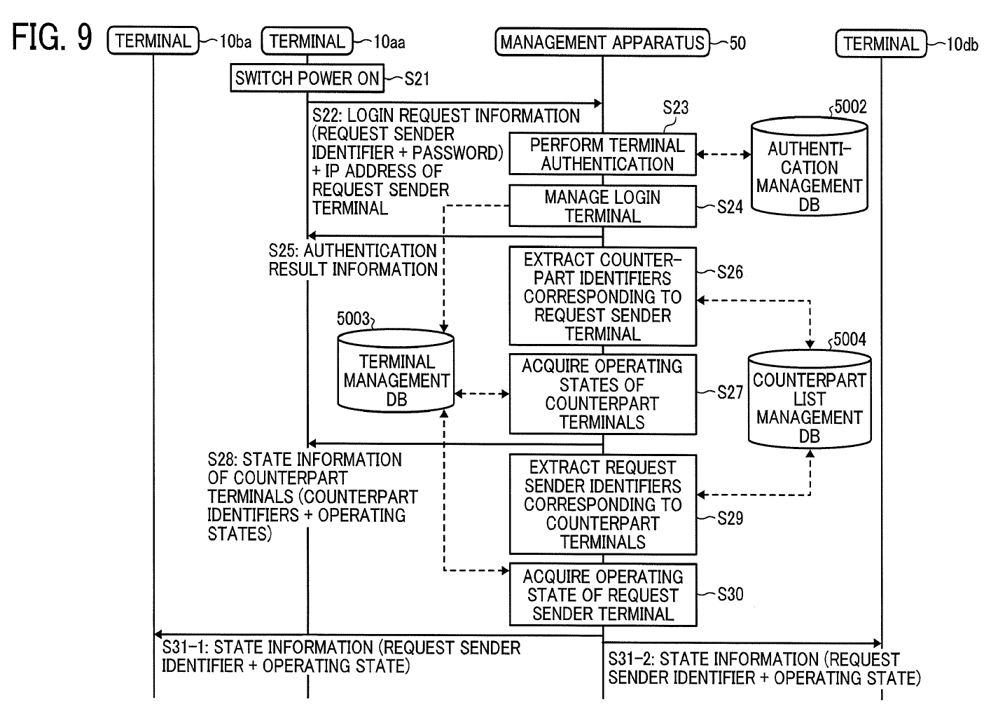

FIG. 9 illustrates a sequence of an exemplary preparatory process according to an embodiment. This process represents an exemplary preparatory process in which a preparatory state is set for the terminal 10aa to be capable of participating in a videoconference in the communication system 1.

Note that, in FIG. 9, information is transmitted and received by using the management-data session sei illustrated in FIG. 2, for example. In addition, the following description will be given by assuming that, in FIG. 9, the identifier of the terminal 10aa is “01aa”, the identifier of the terminal 10ba is “01ba”, and the identifier of the terminal 10db is “01db”.

If a user of the terminal 10aa switches on the power switch 109 of the terminal 10aa, the operation input acceptor 12 accepts the power on operation and controls the power of the terminal 10aa to be switched on (step S21).

Subsequently, in response to acceptance of the power on operation, the communication control 13 of the terminal 10aa transmits login request information for requesting login from the data transmitter/receiver 11 of the terminal 10aa to the management apparatus 50 via the communication network 2 (step S22). The login request information includes a request sender identifier for identifying the terminal 10aa that requests login and a password. The request sender identifier and the password are read from the memory 1000 through the data reader/processor 22.

Note that, upon the management apparatus 50 receiving the login request information transmitted from the terminal 10aa, the management apparatus 50 can acquire the IP address of the terminal 10aa that has transmitted the login request information.

Subsequently, the authenticator 52 of the management apparatus 50 performs terminal authentication by using, as search keys, the identifier and the password included in the login request information received through the data transmitter/receiver 51 (step S23). The authenticator 52 searches the authentication management table 701 included in the authentication management DB 5002 in the memory 5000 and determines whether the same identifier and password as the search keys are managed in the authentication management DB 5002 to perform terminal authentication.

In this step, if the authenticator 52 determines that the same identifier and password as the search keys are not managed, the authenticator 52 determines that the login request is not from a terminal 10 having a legitimate use authority. In this case, the data transmitter/receiver 51 transmits authentication result information representing the authentication result obtained by the authenticator 52 to the terminal 10aa, which has requested login, via the communication network 2, and the preparatory process ends.

On the other hand, if the authenticator 52 determines that the same identifier and password as the search keys are managed, the authenticator 52 determines that the login request is from a terminal 10 having a legitimate use authority. In this case, the terminal manager 53 stores the identifier, the IP address, and the operating state of the terminal 10aa, the reception date and time, and the like in association with one another in the terminal management table 801 included in the terminal management DB 5003 (step S24).

Thus, it is possible to manage the identifier “01aa”, the IP address of the terminal 10aa “1.2.1.3”, the operating state “online (communicating)”, the reception date and time “20xx. 11.10 13:40 (year/month/day, time)” in association with one another in the terminal management table 801. Note that, the identifier, the IP address, and the like may be associated with one another in advance in the terminal management table 801, and the operating state, the reception date and time, and a participant may be associated with one another as necessary.

Subsequently, the data transmitter/receiver 51 of the management apparatus 50 transmits the authentication result information representing the authentication result obtained by the authenticator 52 to the terminal 10aa, which has requested login, via the communication network 2 (step S25).

Subsequently, the terminal extractor 54 of the management apparatus 50 searches the counterpart list management table 702 included in the counterpart list management DB 5004 by using the identifier “01aa” of the terminal 10aa as a search key and extracts counterpart identifiers corresponding to the terminal 10aa (step S26).

In this example, the identifiers “01ab”, “01ba, “01db”, “01dc”, “01ca”, and “01cb” of the terminals 10ab, 10ba, 10db, 10dc, 10ca, and 10cb, respectively, using the counterpart identifiers corresponding to the identifier “01aa” of the terminal 10aa are extracted.

Subsequently, the terminal state acquirer 55 of the management apparatus 50 sets the counterpart identifiers “01ab”, “01ba, “01db”, “01dc”, “01ca”, and “01cb” extracted by the terminal extractor 54 as search keys. By using the search keys, the terminal state acquirer 55 searches the terminal management table 801 included in the terminal management DB 5003 (step S27). The terminal state acquirer 55 reads corresponding operating states “offline”, “online (capable of communicating)”, and “online (communicating)” for each counterpart identifier extracted by the terminal extractor 54. Thus, the operating states of the terminals 10ab, 10ba, 10db, 10dc, 10ca, and 10cb can be acquired. Note that the terminal state acquirer 55 monitors the terminal management DB 5003 and acquires the operating state each time the operating state of a terminal is changed.

Subsequently, the data transmitter/receiver 51 of the management apparatus 50 transmits the state information of the counterpart terminals to the terminal 10aa via the communication network 2 (step S28). The state information of the counterpart terminals includes, for example, the counterpart identifiers “01ab”, “01ba, “01db”, “01dc”, “01ca”, and “01cb” used as search keys in step S27, the state information representing the operating state corresponding to each counterpart identifier, and the like.

Thus, the terminal 10aa can acquire the current operating states “offline”, “online (capable of communicating)”, and “online (communicating)” of the terminals 10ab, 10ba, 10db, 10dc, 10ca, and 10cb, which are counterpart terminals.

Subsequently, the terminal extractor 54 of the management apparatus 50 sets the identifier “01aa” of the terminal 10aa, which has requested login, as a search key. By using the search key, the terminal extractor 54 searches the counterpart list management table 702 included in the counterpart list management DB 5004 (step S29). The terminal extractor 54 extracts the request sender identifiers of other terminals for which the identifier “01aa” of the terminal 10aa has been registered as a counterpart identifier. For example, in the counterpart list management table 702 illustrated in FIG. 7B, the extracted request sender identifiers are “01ab”, “01ba”, and “01db”.

Subsequently, the terminal manager 53 of the management apparatus 50 sets the identifier “01aa” of the terminal 10aa, which has requested login, as a search key. By using the search key, the terminal manager 53 searches the terminal management table 801 included in the terminal management DB 5003 (step S30). The terminal manager 53 acquires the operating state “online (capable of communicating)” of the terminal 10aa, which has requested login.

Subsequently, the data transmitter/receiver 51 of the management apparatus 50 designates, from among the request sender identifiers extracted in step S29, for example, the identifier(s) of terminal(s) 10 whose operating state is online according to the terminal management table 801 illustrated in FIG. 8A. In addition, the data transmitter/receiver 51 transmits the state information including the identifier of the request sender terminal (the terminal 10aa) and an operating state “online (capable of communicating)” to the terminal(s) 10 (e.g., the terminal 10ba and the terminal 10db) corresponding to the designated identifier(s) (steps S31-1 and S31-2).

Note that, when transmitting the state information to the terminals 10ba and 10db, based on the identifiers “01ba” and “01db”, the data transmitter/receiver 51 refers to the IP address of each of the terminals 10 managed in the terminal management table 801.

Thus, the identifier “01aa” and the operating state “online (capable of communicating)” of the terminal 10aa, which has requested login, can be transmitted to the terminals 10db and 10ba. The terminals 10db and 10ba can designate the terminal 10aa, which has requested login, as a counterpart terminal and can communicate with the terminal 10aa.

When step S28 is completed, the generator 18 of the terminal 10aa according to this embodiment generates the counterpart list 1002 (see FIG. 6), and the counterpart list 1002 is stored in the memory 1000.

The counterpart list 1002 includes, as information items, identifiers, the terminal names of terminals using the identifiers, and the operating states of the terminals, and is stored in the memory 1000 in a state in which the terminal name and the operating state are associated according to identifier.

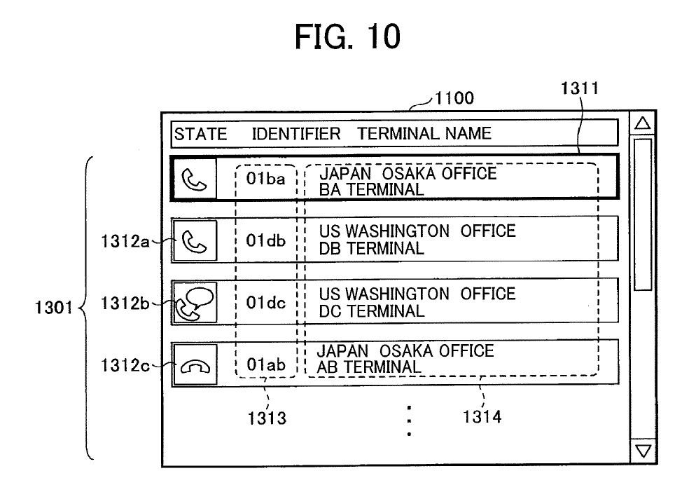

For example, the display control 17 of the terminal 10aa causes the generated counterpart list to be displayed on the display 120. FIG. 10 illustrates an exemplary screen on which the counterpart list is displayed.

In a counterpart list 1301 displayed on a screen 1100 illustrated in FIG. 10, a plurality of selection keys 1311 for selecting a counterpart terminal are displayed. The selection keys 1311 each include corresponding ones of icons 1312a to 1312c that reflect the state information, counterpart identifiers 1313, terminal names 1314, and the like.

The icons include, for example, the icon 1312a representing a state of being online and capable of communicating, the icon 1312b representing a state of being online and currently communicating, the icon 1312c representing a state of being offline and incapable of communicating, and the like.

If the operating state of a counterpart terminal is “online (capable of communicating)”, the generator 18 assigns the icon 1312a to the counterpart terminal. If the operating state of a counterpart terminal is “online (communicating)”, the generator 18 assigns the icon 1312b to the counterpart terminal. If the operating state of a counterpart terminal is “offline”, the generator 18 assigns the icon 1312c to the counterpart terminal.

Now, this application will discuss a process in which a user of the terminal 10aa selects a desired counterpart terminal from among counterpart terminals included in the counterpart list 1002.

In this process, a user of the terminal 10aa needs to find a desired counterpart terminal by looking through the counterpart list 1002. In such a case, as the number of counterpart terminals in the counterpart list 1002 increases, the time and effort needed to find the desired counterpart terminal increases. Furthermore, the desired request destination terminal may be absent in the counterpart list 1002.

In addition, if a conference for restricted participants is to be performed, a user has to find a desired counterpart terminal from the counterpart list 1002 and then has to transmit information representing participation authority for participating in the conference for restricted participants. This makes the operation even more burdensome.

Accordingly, according to this embodiment, a request sender terminal accepts an input operation of a request destination identifier and participation authentication information for participating in a conference for restricted participants and transmits the request destination identifier and participation authentication information to the management apparatus 50. In addition, the request sender terminal obtains a response in accordance with the state of a terminal using the request destination identifier. Thus, according to this embodiment, an operation for participating in a session (conference) for restricted participants is simplified.

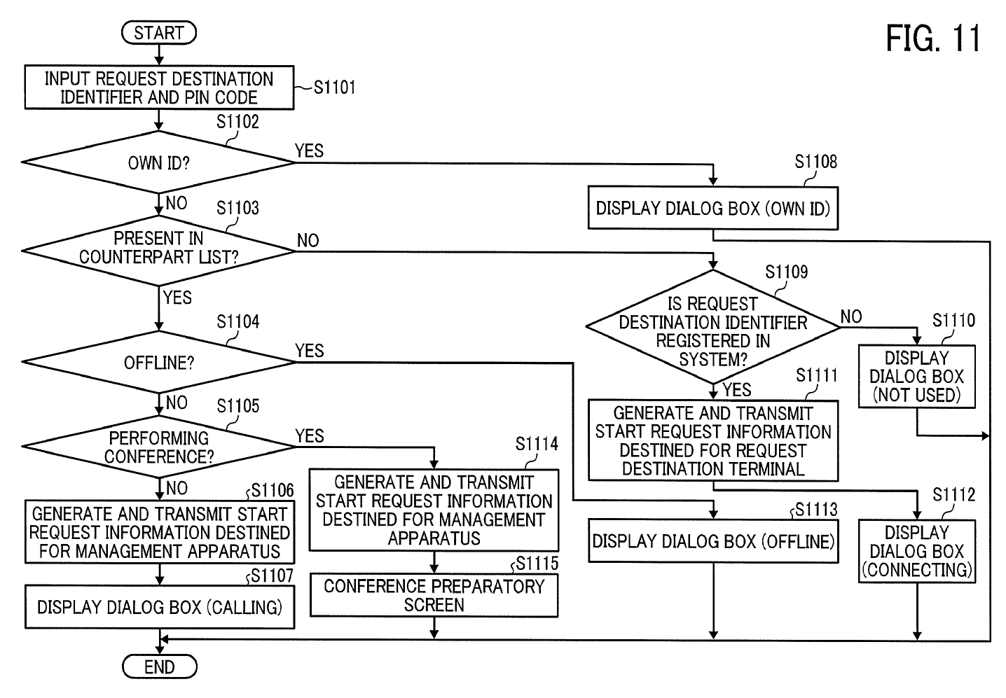

The operation of the terminal 10 according to this embodiment will be described below. FIG. 11 is a flowchart illustrating the operation of the terminal 10 according to the first embodiment.

FIG. 11 illustrates the operation of the terminal 10 performed when a request destination identifier and participation authentication information are input to the terminal 10 to start a new session for restricted participants. In other words, FIG. 11 illustrates the operation of the terminal 10 performed when a user of the terminal 10 starts a conference for restricted participants.

Note that the session (conference) for restricted participants in this embodiment is a session (conference) in which only terminals 10 to which the participation authentication information is input can participate. In other words, the session for restricted participants is a session that requires the participation authentication information to be input as participation authority. In the following description of the embodiment, the participation authentication information will be described as a PIN code.

The operation input acceptor 12 of terminal 10 according to this embodiment accepts a request destination identifier and a PIN code that have been input (step S1101).

Subsequently, the request generator 23 of the terminal 10 determines whether the input request destination identifier is the identifier of the terminal 10 (step S1102). If the input request destination identifier is the identifier of the terminal 10 in step S1102, the terminal 10 proceeds to step S1108 described later.

If the input request destination identifier is not the identifier of the terminal 10 in step S1102, the request generator 23 determines whether the input request destination identifier is present in a counterpart list generated by the generator 18 (step S1103). If the request destination identifier of interest is absent in the counterpart list in step S1103, the request generator 23 proceeds to step S1109 described later.

If the request destination identifier of interest is present in the counterpart list in step S1103, the request generator 23 determines whether the operating state corresponding to the request destination identifier (identifier) of interest is offline by referring to the counterpart list (step S1104).

If the operating state is offline in step S1104, the request generator 23 proceeds to step S1113 described later.

If the operating state is not offline, that is, online, in step S1104, the request generator 23 determines whether the operating state corresponding to the request destination identifier of interest is currently communicating (step S1105). In other words, the request generator 23 determines whether the request destination terminal of interest is performing a conference.

If the operating state is communicating in step S1105, the request generator 23 proceeds to step S1114 described later.

If the operating state is not communicating in step S1105, the request generator 23 generates start request information (first start request information) destined for the management apparatus 50 and transmits the start request information to the management apparatus 50 (step S1106). Subsequently, the display control 17 of the terminal 10 causes a dialog box to be displayed on the display 120, the dialog box indicating that a calling operation is being performed (step S1107), and the process ends.

If the input request destination identifier is the identifier of the terminal 10 in step S1102, the display control 17 of the terminal 10 causes a dialog box to be displayed on the display 120, the dialog box including an error message indicating that the identifier of the terminal 10 has been input (step S1108), and the process ends.

If the input request destination identifier is absent in the counterpart list in step S1103, the request generator 23 notifies the management apparatus 50 of the input request destination identifier and acquires a determination result as to whether the request destination identifier of interest is present in the terminal management DB 5003 (step S1109).

If the request destination identifier of interest is absent in the terminal management DB 5003 in step S1109, the display control 17 causes a dialog box to be displayed on the display 120, the dialog box including an error message indicating that the identifier is not present in the system (step S1110), and the process ends.

If the request destination identifier of interest is present in the terminal management DB 5003 in step S1109, the request generator 23 generates start request information (second start request information) destined for the request destination terminal and transmits the start request information to the management apparatus 50 (step S1111). Subsequently, the display control 17 of the terminal 10 causes a dialog box to be displayed on the display 120, the dialog box indicating that connection with the designated request destination terminal is being established (step S1112), and the process ends.

If the operating state corresponding to the input request destination identifier is offline in step S1104, the display control 17 of the terminal 10 causes a dialog box to be displayed on the display 120, the dialog box indicating that the request destination terminal is offline (step S1113), and the process ends.

If the operating state corresponding to the input request destination identifier is communicating in step S1105, the request generator 23 of terminal 10 generates start request information (first start request information) destined for the management apparatus 50 and transmits the start request information to the management apparatus 50 (step S1114). Subsequently, the display control 17 of the terminal 10 causes a conference preparatory screen to be displayed on the display 120 (step S1115), and the process ends.

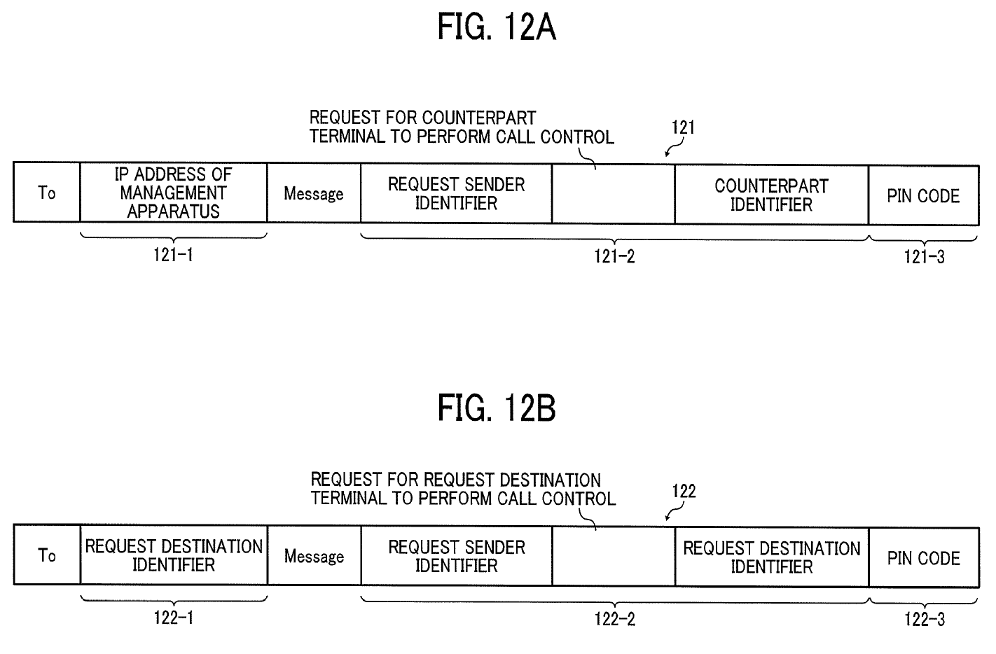

Now, the start request information generated by the request generator 23 according to this embodiment will be described. FIGS. 12A and 12B illustrate the start request information. FIG. 12A illustrates exemplary first start request information destined for the management apparatus 50, and FIG. 12B illustrates exemplary second start request information destined for the request destination terminal.

Start request information 121 illustrated in FIG. 12A includes a destination 121-1, a message 121-2, and participation authentication information 121-3.

The destination 121-1 is, for example, the IP address of the management apparatus 50. Note that the destination 121-1 does not have to be the IP address of the management apparatus 50 and may be any information for designating the management apparatus 50.

The message 121-2 includes the request sender identifier, a request for the counterpart terminal to perform call control, and the counterpart identifier. In other words, the message 121-2 is a request for the counterpart terminal to communicate with the request sender terminal. The participation authentication information 121-3 is, for example, the PIN code that has been input.

Start request information 122 illustrated in FIG. 12B includes a destination 122-1, a message 122-2, and participation authentication information 122-3.

The destination 122-1 is the request destination identifier that has been input to the terminal 10 serving as the request sender terminal. Note that the destination 122-1 does not have to be the request destination identifier and may be any information for designating a terminal using the request destination identifier.

The message 122-2 includes the request sender identifier, a request for the request destination terminal to perform call control, and the request destination identifier. In other words, the message 122-2 is a request for the request destination terminal to communicate with the request sender terminal. The participation authentication information 122-3 is, for example, the PIN code that has been input.

In this embodiment, upon the start request information being received, the management apparatus 50 transmits a message and the participation authentication information to an apparatus that is designated as a destination in the start request information.

For example, in the start request information 121, the own apparatus (the management apparatus 50) is designated as the destination 121-1. Thus, the destination determiner 60 of the management apparatus 50 determines that the destination of the message 121-2 and the participation authentication information 121-3 included in the start request information 121 is the management apparatus 50, and the management apparatus 50 interprets the message.

In addition, in the start request information 122, the request destination terminal is designated as the destination 122-1. Thus, the destination determiner 60 of the management apparatus 50 determines that the destination of the message 122-2 and the participation authentication information 122-3 included in the start request information 122 is the request destination terminal. Then, the management apparatus 50 transfers the message 122-2 and the participation authentication information 122-3 to the request destination terminal.

In the above manner, in the terminal 10 according to this embodiment, the request destination identifier and the participation authentication information that have been input can be included in a piece of start request information. Thus, in this embodiment, an operation for participating in a session for restricted participants is performed by only issuing a calling instruction by inputting an identifier and a PIN code.

In addition, in this embodiment, the destination of a message including a request for performing call control can be designated in accordance with the presence or absence of the request destination identifier in the counterpart list. More specifically, if the request destination identifier is absent in the counterpart list, the start request information according to this embodiment can serve as a request for transferring the message to the request destination terminal indicated by the destination.

Note that the start request information generated by the terminal 10 is not limited to the examples in FIGS. 12A and 12B. The start request information may include information other than the information illustrated in FIGS. 12A and 12B.

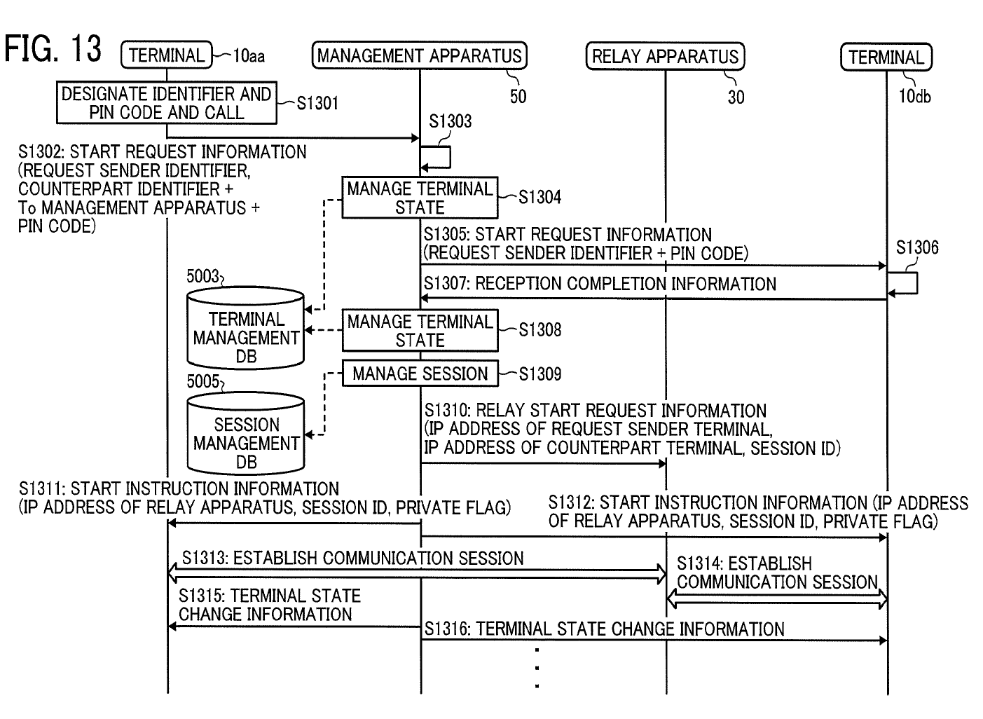

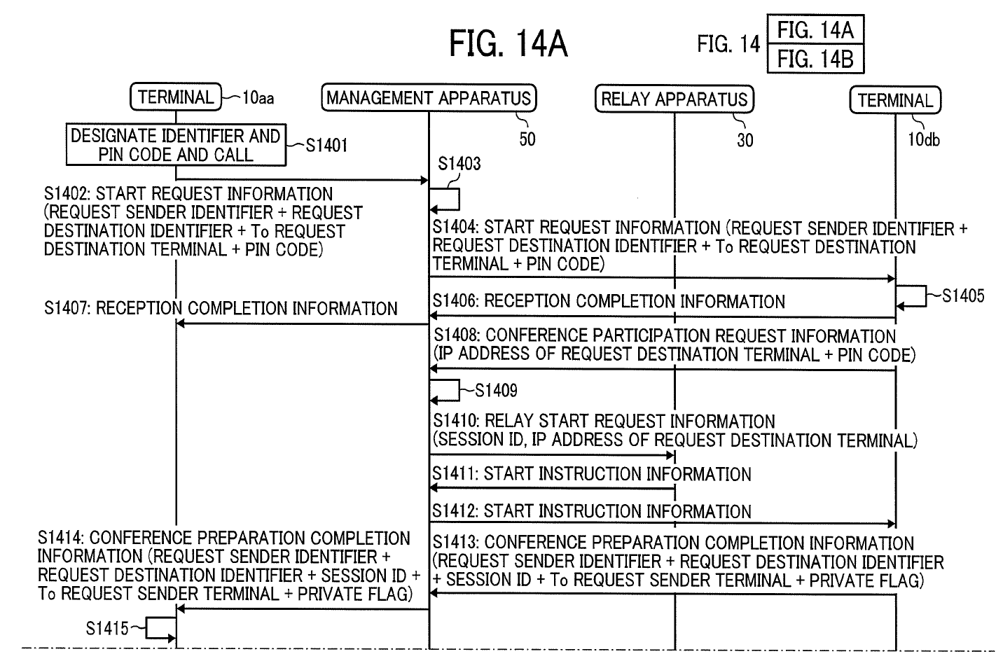

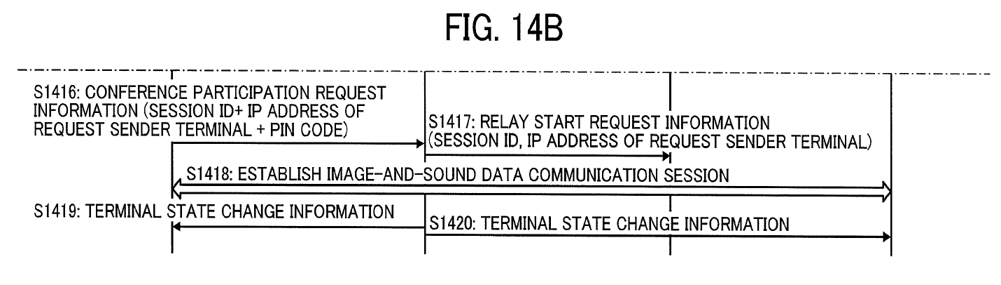

Next, the operation of the communication system 1 according to this embodiment will be described with reference to FIGS. 13 and 14. FIG. 13 illustrates a sequence of the operation of the communication system 1 according to the first embodiment.

FIG. 13 illustrates the operation of the communication system 1 performed if the identifier that has been input to the terminal 10 is present in the counterpart list.

In addition, FIG. 13 illustrates the operation in which the terminal 10aa requests the terminal 10db to start communication such as a videoconference and in which content data (e.g., image data and sound data) is communicated. Note that in FIG. 13, various kinds of management data are transmitted and received between each terminal 10 and the management apparatus 50 on the management-data session sei illustrated in FIG. 2.

The operation input acceptor 12 of the terminal 10aa accepts a user's input operation of the identifier (the request destination identifier) of the request destination terminal (the terminal 10db) and the participation authentication information (the PIN code) (step S1301).

Subsequently, the terminal 10aa generates, by using the request generator 23, start request information and transmits the start request information to the management apparatus 50 (step S1302). Since the identifier of the terminal 10db is present in the counterpart list 1002, the request generator 23 generates start request information 121 destined for the management apparatus 50, and the start request information 121 is transmitted.

In response to the start request information being received, the destination determiner 60 of the management apparatus 50 determines whether the destination included in the start request information is the management apparatus 50 (step S1303). Here, since the destination included in the start request information is the management apparatus 50, the management apparatus 50 interprets the message included in the start request information.

Subsequently, the terminal manager 53 of the management apparatus 50 updates the terminal management table 801 included in the terminal management DB 5003, based on the request sender identifier included in the start request information (step S1304). For example, the terminal manager 53 changes information about the operating state corresponding to the identifier “01aa” (the request sender identifier) of the terminal 10aa to “online (communicating)”, and updates information about the reception date and time.

Subsequently, the session manager 56 of the management apparatus 50 transmits to the terminal 10db serving as the counterpart terminal, the start request information for requesting the start of a session (step S1305). The start request information includes, for example, the request sender identifier of the terminal 10aa serving as a request sender terminal, participation authentication information, and the like.

In response to the start request information being received from the management apparatus 50, for example, the terminal 10db accepts a responding operation performed by a user of the terminal 10db (step S1306), generates reception completion information by using the response generator 24, and transmits the reception completion information to the management apparatus 50 (step S1307).

The reception completion information includes, for example, a counterpart identifier that is the identifier of the terminal 10db. Note that the reception completion information may be automatically transmitted from the terminal 10db, for example.

Subsequently, upon the reception completion information being received from the terminal 10db, the terminal manager 53 of the management apparatus 50 updates the terminal management table 801 included in the terminal management DB 5003, on the basis of the identifier of the terminal 10db included in the reception completion information (step S1308). For example, the terminal manager 53 changes information about the operating state corresponding to the identifier “01db” of the terminal 10db to “online (communicating)” and updates information about the reception date and time.

Subsequently, the session manager 56 of the management apparatus 50 generates a session ID that is an identifier for identifying a communication session. In addition, the session manager 56 stores the relay apparatus ID of the relay apparatus 30, the request sender identifier, and the counterpart identifier in association with the generated session ID in the session management table 802 included in the session management DB 5005 (step S1309).

Subsequently, the session manager 56 of the management apparatus 50 transmits to the relay apparatus 30, relay start request information for requesting the start of a communication session relay (step S1310). The relay start request information includes, for example, the session ID generated in step S1309, the IP address of the request sender terminal, the IP address of the counterpart terminal, and the like.

Subsequently, the session manager 56 of the management apparatus 50 transmits to the terminals 10aa and 10db, start instruction information as an instruction for starting a session (steps S1311 and S1312). The start instruction information includes, for example, the session ID generated in step S1309, the IP address of the relay apparatus 30, a private flag, and the like.

The private flag is information indicating that a session indicated by the session ID generated in step S1309 is a session for restricted participants. Thus, in steps S1311 and S1312, the terminals 10aa and 10db receive start instruction information for a session for restricted participants.

Subsequently, the communication control 13 of the terminal 10aa establishes a communication session (session sed) with the relay apparatus 30 by using the start instruction information received from the management apparatus 50 (step S1313).

Likewise, the communication control 13 of the terminal 10db establishes a communication session (session sed) with the relay apparatus 30 by using the start instruction information received from the management apparatus 50 (step S1314).

Through the above process, the terminals 10aa and 10db can participate in the same communication session and can transmit content data to each other through the relay apparatus 30. That is, the terminals 10aa and 10db can perform a videoconference.

Subsequently, the terminal manager 53 of the management apparatus 50 transmits to each of the terminals 10 that are registered in the terminal management DB 5003, terminal state change information that is a notification of a change in the states of the terminals 10 (steps S1315 and S1316). In the example in FIG. 13, the terminal state change information includes the identifiers of the terminals 10aa and 10db whose terminal states have been changed, the state information indicating the operating states of the terminals 10aa and 10db, and the like. Note that the state information may include the session ID of the session in which the terminals 10 participate.

FIG. 14 illustrates a second sequence of the operation of the communication system 1 according to the first embodiment. FIG. 14 illustrates the operation of the communication system 1 performed if the identifier that has been input to the terminal 10aa is absent in the counterpart list.

In addition, FIG. 14 illustrates the operation in which the terminal 10aa requests the terminal 10db to start communication such as a videoconference and in which content data (e.g., image data and sound data) is communicated.

The operation input acceptor 12 of the terminal 10aa accepts a user's input operation of the identifier (the request destination identifier) of the request destination terminal (the terminal 10db) and the participation authentication information (the PIN code) (step S1401).

Subsequently, the terminal 10aa generates, by using the request generator 23, start request information and transmits the start request information to the management apparatus 50 (step S1402). Since the identifier of the terminal 10db is absent in the counterpart list 1002, the request generator 23 generates start request information 122 destined for the terminal 10db, and the start request information 122 is transmitted.

Upon the start request information being received, the destination determiner 60 of the management apparatus 50 determines whether the destination included in the start request information is the management apparatus 50 (step S1403). Here, since the destination included in the start request information is the identifier of the terminal 10db, the management apparatus 50 transfers the start request information to the terminal 10db (step S1404).

In addition, the management apparatus 50 holds the PIN code included in the start request information, as participation authentication information corresponding to the identifier (the request sender identifier) of the terminal 10aa, in the terminal management table 801.

Upon the start request information being received, the terminal 10db, for example, accepts a responding operation performed by a user of the terminal 10db (step S1405), generates reception completion information by using the response generator 24 and transmits the reception completion information to the management apparatus 50 (step S1406).

The reception completion information includes, for example, a request destination identifier that is the identifier of the terminal 10db. Note that the reception completion information may be automatically transmitted from the terminal 10db, for example.

Upon the reception completion information being received, the management apparatus 50 transfers the reception completion information to the terminal 10aa (step S1407). Note that the reception completion information does not have to be transmitted through the management apparatus 50 and may be transmitted directly to the terminal 10aa.

Subsequently, the terminal 10db generates, by using the request generator 23, conference (session) participation request information and transmits the conference participation request information to the management apparatus 50 (step S1408). The conference participation request information includes the IP address of the terminal 10db serving as the request destination terminal and the PIN code included in the start request information received in step S1404. At this time, the management apparatus 50 holds the PIN code included in the conference participation request information, as participation authentication information corresponding to the identifier of the terminal 10db, in the terminal management table 801.

Upon the conference participation request information being received, the session manager 56 of the management apparatus 50 generates a session ID that is an identifier for identifying a communication session (step S1409). Subsequently, the session manager 56 of the management apparatus 50 transmits relay start request information for requesting the start of a communication session relay to the relay apparatus 30 (step S1410). The relay start request information includes, for example, the session ID generated in step S1409 and the IP address of the terminal 10db serving as the request destination terminal.

Upon the relay start request information being received, the relay apparatus 30 transmits start instruction information to the management apparatus 50 (step S1411). The start instruction information includes, for example, the session ID and the IP address of the relay apparatus 30.

Upon the start instruction information being received from the relay apparatus 30, the management apparatus 50 transmits the start instruction information to the terminal 10db serving as the request destination terminal (step S1412). The start instruction information includes, for example, in addition to the session ID and the IP address of the relay apparatus 30, the IP address of the terminal 10db serving as the request destination terminal.

Upon the start instruction information being received, the terminal 10db generates, by using the request generator 23, conference preparation completion information and transmits the conference preparation completion information to the management apparatus 50 (step S1413).

The conference preparation completion information according to this embodiment is information indicating that the preparation for participating in a session has been completed and can be session preparation completion information. The conference preparation completion information includes the identifier of the terminal 10aa serving as the request sender terminal, the identifier of the terminal 10db serving as the request destination terminal, and the session ID. The conference preparation completion information further includes a private flag indicating that the session indicated by the session ID is a session for restricted participants.

Upon the conference preparation completion information being received, the management apparatus 50 transfers the conference preparation completion information to the terminal 10aa that is the destination of the conference preparation completion information (step S1414).

Upon the conference preparation completion information being received, the type determiner 25 of the terminal 10aa determines whether the conference for which participation preparation has been completed in the request destination terminal is a session for restricted participants (step S1415).

Specifically, the type determiner 25 of the terminal 10aa determines whether a private flag is added to the conference preparation completion information. In the example in FIG. 14, since the private flag is added to the conference preparation completion information, it is determined that participation preparation for a session for restricted participants has been completed in the request destination terminal.

Subsequently, the terminal 10aa generates, by using the request generator 23, conference participation request information and transmits the conference participation request information to the management apparatus 50 (step S1416). The conference participation request information includes the session ID, the IP address of the terminal 10aa serving as the request sender terminal, and the PIN code.

Upon the conference participation request information being received, the session manager 56 of the management apparatus 50 transmits relay start request information for requesting the start of a communication session relay to the relay apparatus 30 (step S1417). The relay start request information includes, for example, the session ID and the IP address of the terminal 10aa serving as the request sender terminal.

Subsequently, the communication control 13 of each of the terminals 10aa and 10db establishes a communication session (session sed) with the relay apparatus 30 (step S1418).

Through the above process, the terminals 10aa and 10db can participate in a communication session for restricted participants and can transmit content data to each other through the relay apparatus 30. That is, the terminals 10aa and 10db can perform a videoconference.

Subsequently, the terminal manager 53 of the management apparatus 50 transmits to each of the terminals 10 that are registered in the terminal management DB 5003, terminal state change information that is a notification of a change in the states of the terminals 10 (steps S1419 and S1420).

In the above manner, according to this embodiment, the terminal 10 serving as the request sender terminal transmits to the request destination terminal, the start request information including the request destination identifier and the participation authentication information when starting a session. If start instruction information or conference preparation completion information including a private flag is received as a response to the start request information, the terminal 10 serving as the request sender terminal establishes communication with the request destination terminal in a conference for restricted participants.

Thus, according to this embodiment, when a session for restricted participants is to be performed, it is unnecessary to inquire in advance the state and the like of the request destination terminal, and a user of the request sender terminal has only to input the identifier of the request destination terminal and a PIN code and to issue an instruction for calling the management apparatus 50 and then wait for a response.

Accordingly, according to this embodiment, an operation for performing a session for restricted participants can be simplified, thereby increasing usability.

Note that the examples in FIGS. 13 and 14 illustrate cases in which the terminal 10db serving as the request destination terminal waits in a state of being capable of participating in a session for restricted participants. However, depending on the state of the request destination terminal, the request destination terminal may be incapable of participating in a session for restricted participants. In such a case, the request destination terminal transmits a response to the request sender terminal in accordance with the state of the request destination terminal. Details of a process performed by the request destination terminal in this case will be described later.

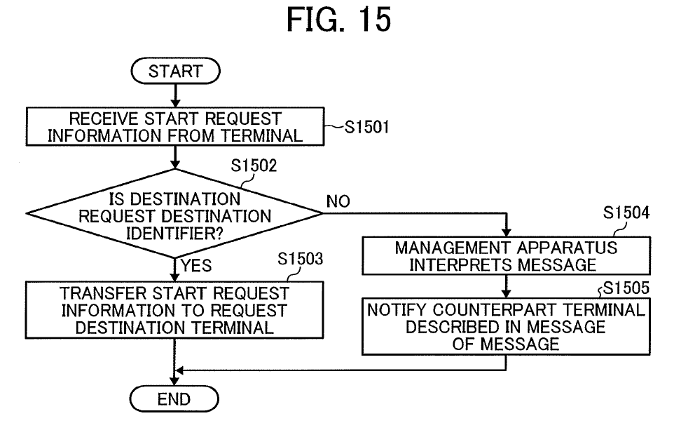

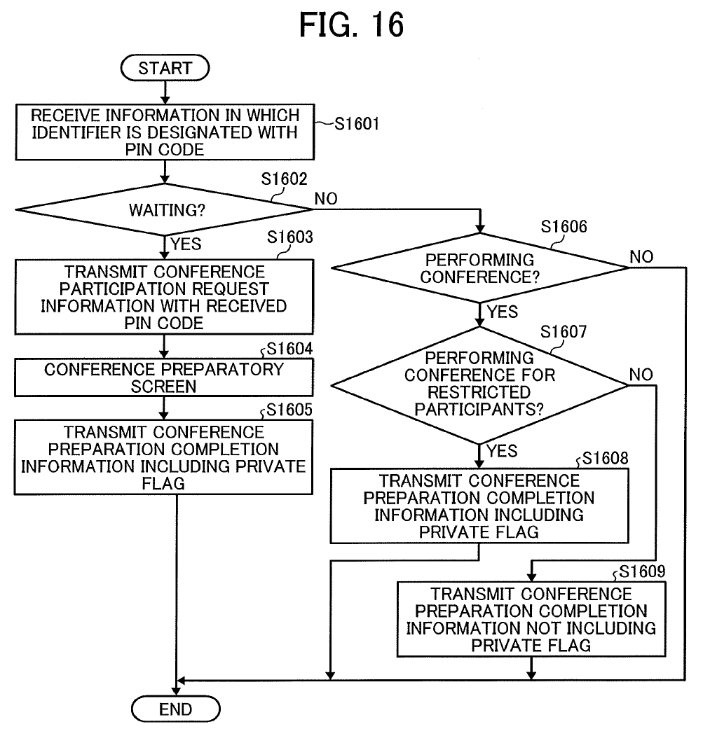

Next, the operation of the management apparatus 50 and the terminal 10db serving as the request destination terminal in the communication system 1 according to this embodiment will be described with reference to FIGS. 15 and 16.

FIG. 15 is a flowchart illustrating the operation of the management apparatus 50 according to the first embodiment. FIG. 15 illustrates the operation performed if the management apparatus 50 receives start request information. In other words, FIG. 15 illustrates details of step S1303 in FIG. 13 or step S1403 in FIG. 14.

Upon the start request information being received from the request sender terminal (step S1501), the destination determiner 60 of the management apparatus 50 according to this embodiment determines whether the destination included in the start request information is the request destination identifier (step S1502).

If the destination is the request destination identifier in step S1502, the management apparatus 50 transfers the start request information to the request destination terminal indicated by the destination (step S1503), and the process ends. That is, the management apparatus 50 determines that the start request information is a request for transferring the start request information to the destination of the start request information.

If the destination is not the request destination identifier in step S1502, that is, if the destination is the IP address of the management apparatus 50, the management apparatus 50 interprets the message included in the start request information (step S1504). Subsequently, the management apparatus 50 notifies a terminal (counterpart terminal) of the content of the message, the terminal using the counterpart identifier described in the message in the start request information (step S1505), and the process ends.

Specifically, the management apparatus 50 notifies the counterpart terminal described in the message, of a request for performing call control described in the message in the start request information.

Next, the operation of the request destination terminal according to this embodiment will be described with reference to FIG. 16. FIG. 16 is a flowchart illustrating the operation of the request destination terminal according to the first embodiment.

In FIG. 16, description will be given by assuming that the request destination terminal is the terminal 10db. In addition, FIG. 16 illustrates a process of the terminal 10db performed if the identifier of the terminal 10db is absent in the counterpart list and if start request information destined for the identifier of the terminal 10db is generated by the request sender terminal 10aa.

In response to start request information in which the identifier (the request destination identifier) of the terminal 10db is designated and to which a PIN code is added being received (step S1601), the terminal 10db determines whether the terminal 10db is waiting (step S1602). Note that “waiting” means a state in which communication is possible and is not performed yet. If the terminal 10db is not waiting in step S1602, the process proceeds to step S1606 described later.

If the terminal 10db is waiting in step S1602, the request generator 23 of the terminal 10db generates conference participation request information including the received PIN code and transmits the conference participation request information to the management apparatus 50 (step S1603).

Subsequently, the display control 17 of the terminal 10db causes a conference preparatory screen to be displayed (step S1604). Subsequently, the terminal 10db generates, by using the request generator 23, conference preparation completion information including a private flag and transmits the conference preparation completion information to the management apparatus 50 (step S1605), and the process ends.

If the terminal 10db is not waiting in step S1602, the terminal 10db determines whether the terminal 10db is performing a conference (step S1606) In other words, the terminal 10db determines whether the terminal 10db is communicating with another terminal 10.

If the terminal 10db is not performing a conference in step S1606, that is, the terminal 10db is not communicating, the terminal 10db ends the process in order to indicate that the terminal 10db is offline. Note that if the terminal 10db is offline in step S1606, the management apparatus 50 may notify the terminal 10aa serving as the request sender terminal that the terminal 10db is offline.

If the terminal 10db is performing a conference in step S1606, that is, the terminal 10db is communicating, the terminal 10db determines whether the conference in which the terminal 10db is participating is a conference for restricted participants (step S1607).

If the conference is a conference for restricted participants in step S1607, the terminal 10db generates, by using the request generator 23, conference preparation completion information including a private flag and transmits the conference preparation completion information to the management apparatus 50 (step S1608), and the process ends.

The conference preparation completion information generated in step S1608 only indicates that the terminal 10db is participating in a conference for restricted participants. Thus, the conference for restricted participants indicated by the conference preparation completion information generated in this step might be different from the conference indicated by the start request information received in step S1601.

In this embodiment, for example, after the conference preparation completion information generated in step S1608 has been received, the management apparatus 50 may request a terminal 10db to input a PIN code. Then, if the PIN code that is input to the terminal 10db is the same as the PIN code received in step S1601, the management apparatus 50 may establish a session between the terminal 10aa and the terminal 10db.

In addition, if the PIN code that is input to the terminal 10db is not the same as the PIN code received in step S1601, the management apparatus 50 may notify the terminal 10aa that the terminal 10db is participating in another conference for restricted participants.

If the conference is not a conference for restricted participants in step S1607, the terminal 10db generates, by using the request generator 23, conference preparation completion information not including a private flag and transmits the conference preparation completion information to the management apparatus 50 (step S1609), and the process ends.

In this case, the management apparatus 50 may notify the terminal 10aa serving as the request sender terminal that the terminal 10db is participating in another conference for which participants are not restricted.

In the above manner, according to this embodiment, when a conference for restricted participants is to be performed, by only inputting the identifier of the request destination terminal and a PIN code to the request sender terminal and issuing an instruction for transmitting the start request information, a response including information as to whether participation in a conference is permitted in accordance with the state of the request destination terminal can be obtained. Accordingly, according to this embodiment, an operation for checking the state of the request destination terminal can be skipped, thereby simplifying the operation.

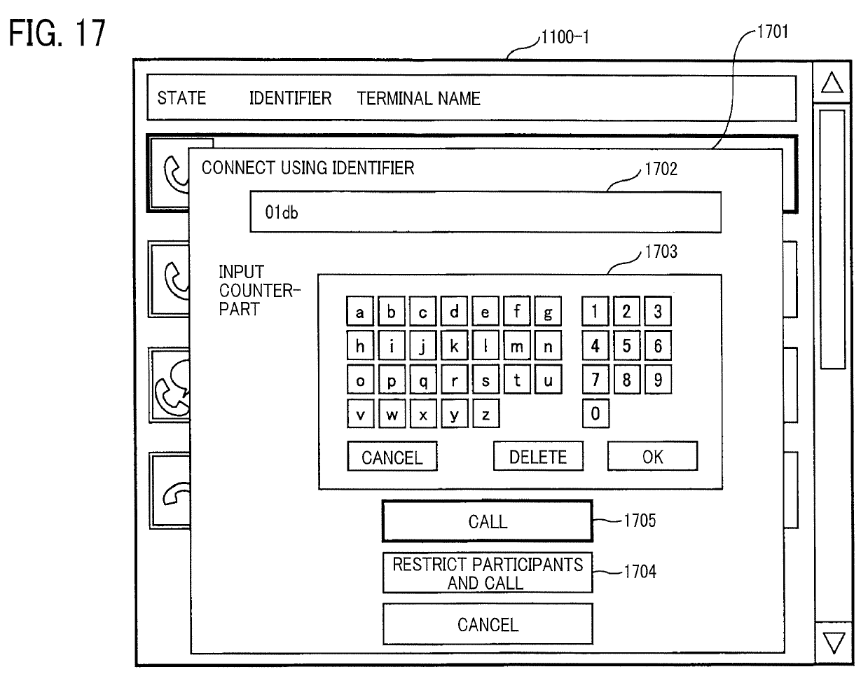

Next, exemplary screens displayed on the display 120 will be described with reference to FIGS. 17 to 24.

FIG. 17 illustrates an exemplary screen for inputting an identifier. A dialog box 1701 including an input field for the identifier of a terminal using a request destination identifier is displayed on a screen 1100-1 illustrated in FIG. 17.

An input field 1702, a software keyboard 1703, keys 1704 and 1705 are displayed in the dialog box 1701.

The identifier of a request destination terminal is input into the input field 1702. The software keyboard 1703 is used for inputting the identifier. The key 1704 is a key used for issuing a calling instruction by adding participation authentication information. The key 1705 is a key for issuing a calling instruction by not adding participation authentication information.

When the key 1704 is selected, a screen 1100-2 described later is displayed on the display 120. When the key 1705 is selected, the request sender terminal generates start request information for a conference for which participants are not restricted and transmits the start request information to the management apparatus 50.

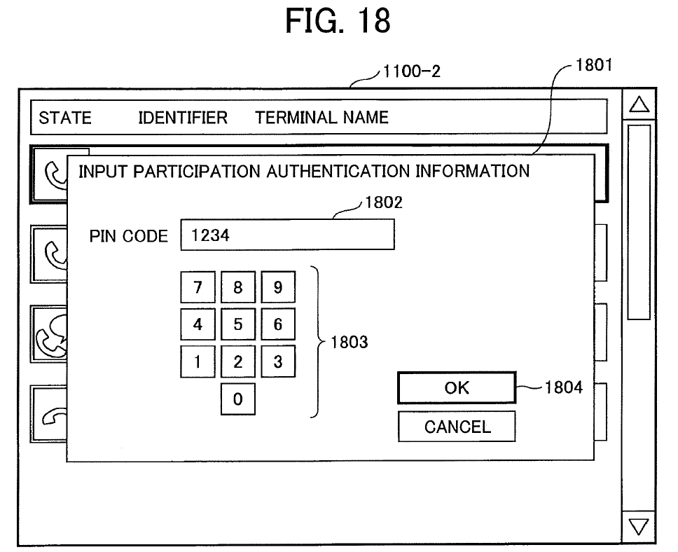

FIG. 18 illustrates an exemplary screen for inputting participation authentication information. A dialog box 1801 including an input field for the participation authentication information is displayed on the screen 1100-2 illustrated in FIG. 18.

An input field 1802, a ten-key pad 1803, a key 1804 are displayed in the dialog box 1801.

A PIN code that is the participation authentication information is input into the input field 1802. The ten-key pad 1803 is used for inputting the PIN code. The key 1804 is selected to complete inputting the PIN code.

When the key 1804 is selected on the screen 1100-2, the screen of the terminal 10 may transition to the screen 1100-1, and the dialog box 1701 including the key 1704 for issuing a calling instruction for restricted participants may be displayed.

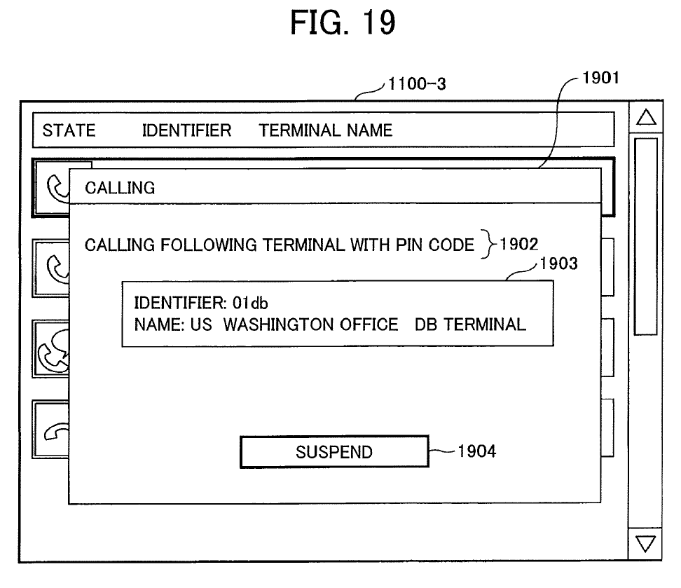

FIG. 19 illustrates an exemplary screen by which a user is notified of a calling operation for the management apparatus 50. A dialog box 1901 is displayed on a screen 1100-3 illustrated in FIG. 19. The dialog box 1901 is the dialog box displayed in step S1107 in FIG. 11.

Display fields 1902 and 1903 and a key 1904 are displayed in the dialog box 1901.

A message indicating that the start request information to which the PIN code is added has been transmitted to the management apparatus 50 is displayed in the display field 1902. In the display field 1903, the identifier of the request destination terminal that has been input into the input field 1702 and the name of the request destination terminal specified by the identifier are displayed.

The key 1904 is a key for suspending the calling operation for the management apparatus 50. When the key 1904 is selected, the terminal 10 suspends the calling operation for the management apparatus 50.

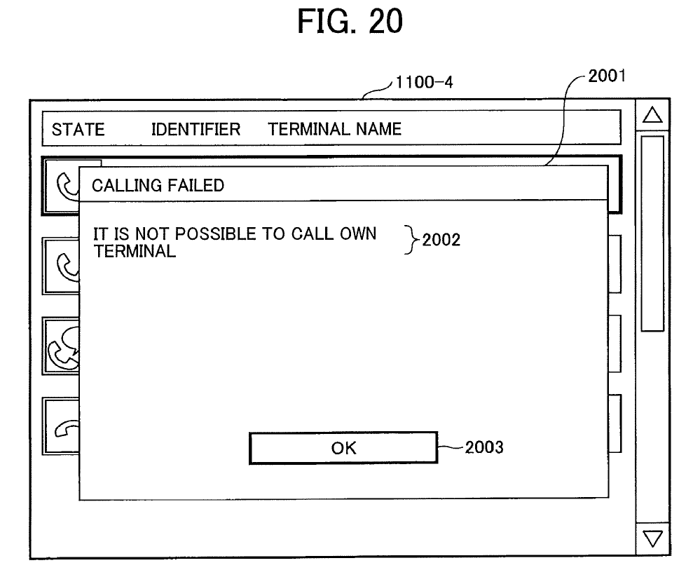

FIG. 20 is a first diagram illustrating an exemplary screen on which an error message is displayed. A dialog box 2001 is displayed on a screen 1100-4 illustrated in FIG. 20. The dialog box 2001 is the dialog box displayed in step S1108 in FIG. 11.

A message 2002 and a key 2003 are displayed in the dialog box 2001.

The message 2002 is an error message indicating that calling is not possible because the identifier of the request destination terminal that has been input into the input field 1702 is the identifier of the request sender terminal.

The key 2003 is a key used for causing the screen 1100-4 to transition to the screen 1100-1 or the like. When the key 2003 is selected, the terminal 10 may cause the dialog box 2001 to disappear from the screen 1100-4 and may cause the screen 1100-4 to transition to the screen 1100 illustrated in FIG. 10. In addition, when the key 2003 is selected, the terminal 10 may cause the dialog box 2001 to disappear from the screen 1100-4 and may cause the screen 1100-4 to transition to the screen 1100-1 on which the dialog box 1701 is displayed.

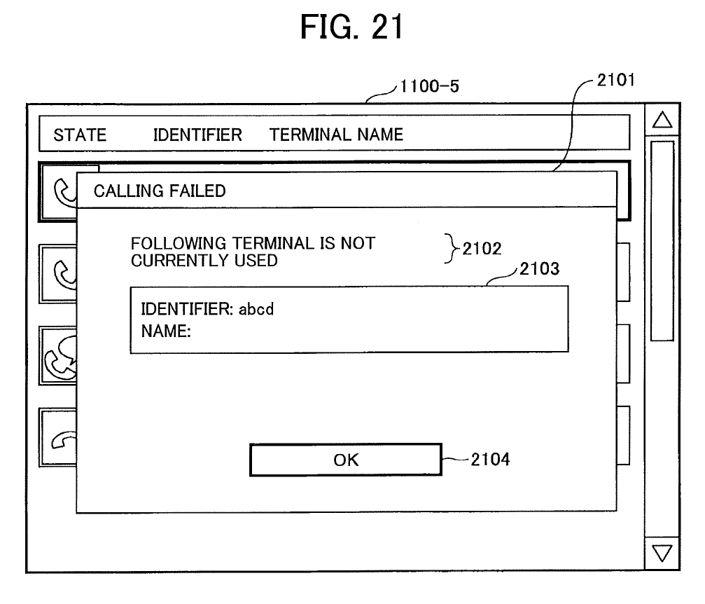

FIG. 21 is a second diagram illustrating an exemplary screen on which an error message is displayed. A dialog box 2101 is displayed on a screen 1100-5 illustrated in FIG. 21. The dialog box 2101 is the dialog box displayed in step S1110 in FIG. 11.

A message 2102, a display field 2103, and a key 2104 are displayed in the dialog box 2101.

The message 2102 is an error message indicating that the identifier of the request destination terminal that has been input into the input field 1702 is not present in the terminal management DB 5003 and that calling is not possible. The identifier that has been input into the input field 1702 is displayed in the display field 2103.

The key 2104 is a key for causing the screen 1100-5 to transition to the screen 1100-1 or the like. When the key 2104 is selected, the terminal 10 may cause the dialog box 2101 to disappear from the screen 1100-5 and may cause the screen 1100-5 to transition to the screen 1100 illustrated in FIG. 10. In addition, when the key 2104 is selected, the terminal 10 may cause the dialog box 2101 to disappear from the screen 1100-5 and may cause the screen 1100-5 to transition to the screen 1100-1 on which the dialog box 1701 is displayed.

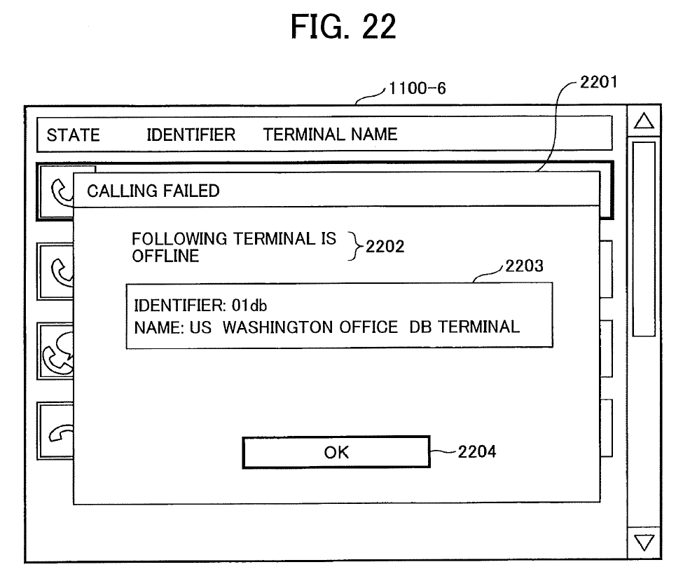

FIG. 22 is a third diagram illustrating an exemplary screen on which an error message is displayed. A dialog box 2201 is displayed on a screen 1100-6 illustrated in FIG. 22. The dialog box 2201 is the dialog box displayed in step S1113 in FIG. 11.

A message 2202, a display field 2203, and a key 2204 are displayed in the dialog box 2201.

The message 2202 is an error message indicating that the request destination terminal specified by the identifier that has been input into the input field 1702 is offline and that calling is not possible. The identifier that has been input into the input field 1702 and the name of the request destination terminal specified by the identifier are displayed in the display field 2203.

The key 2204 is a key used for causing the screen 1100-6 to transition to the screen 1100-1 or the like. When the key 2204 is selected, the terminal 10 may cause the dialog box 2201 to disappear from the screen 1100-6 and may cause the screen 1100-6 to transition to the screen 1100 illustrated in FIG. 10. In addition, when the key 2204 is selected, the terminal 10 may cause the dialog box 2201 to disappear from the screen 1100-6 and may cause the screen 1100-6 to transition to the screen 1100-1 on which the dialog box 1701 is displayed.

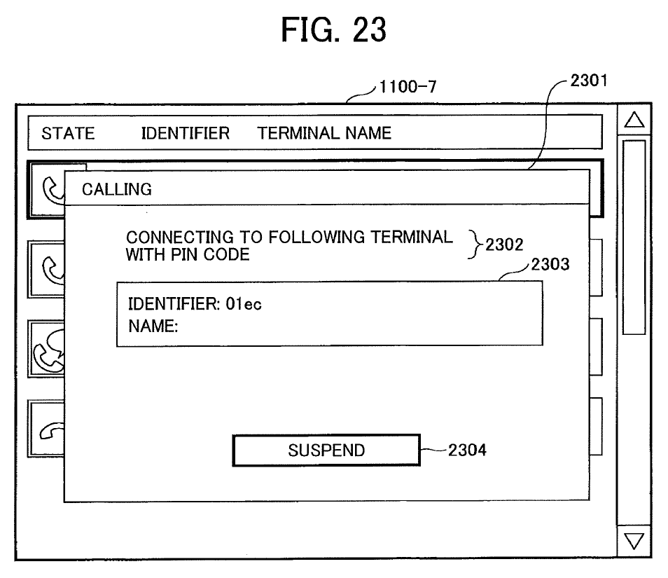

FIG. 23 illustrates an exemplary screen by which a user is notified of connection to the request destination terminal. A dialog box 2301 is displayed on a screen 1100-7 illustrated in FIG. 23. The dialog box 2301 is the dialog box displayed in step S1112 in FIG. 11.

Display fields 2302 and 2303 and a key 2304 are displayed in the dialog box 2301.

A message indicating that the start request information to which the PIN code is added has been transmitted through the management apparatus 50 to the request destination terminal specified by the identifier is displayed in the display field 2302. In addition, the identifier that has been input into the input field 1702 and the name of the request destination terminal specified by the identifier are displayed in the display field 2303.

The key 2304 is a key used for suspending the calling operation for the management apparatus 50. When the key 2304 is selected, the terminal 10 suspends the connection to the request destination terminal.

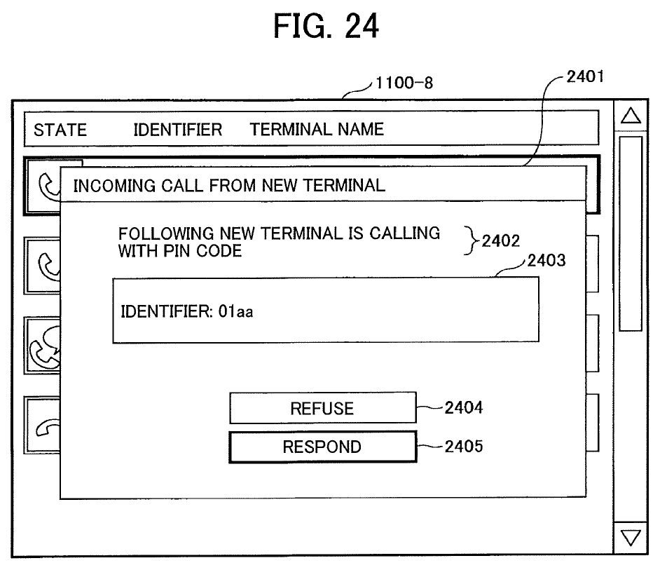

FIG. 24 illustrates an exemplary screen by which a user is notified of an incoming call from the request sender terminal. A dialog box 2401 is displayed on a screen 1100-8 illustrated in FIG. 24. The dialog box 2401 is displayed when the terminal 10 receives start request information.

Display fields 2402 and 2403 and keys 2404 and 2405 are displayed in the dialog box 2401.

A message indicating that the start request information to which the PIN code is added has been received is displayed in the display field 2402. The identifier of the request sender terminal that has transmitted the start request information is displayed in the display field 2403.

The key 2404 is a key used for refusing to respond to the incoming call. The key 2405 is a key for responding to the incoming call.

If the key 2404 is selected, the terminal 10 does not transmit to the request sender terminal, reception completion information for the start request information. In addition, if the key 2405 is selected, the terminal 10 transmits to the request sender terminal, reception completion information for the start request information.

In the above manner, according to this embodiment, a dialog box in accordance with the state is displayed on the display 120 when the terminal 10 serves as the request sender terminal and as the request destination terminal.

### Second Embodiment

Now, a second embodiment will be described below with reference to some drawings. In the second embodiment, a case in which a terminal participates in a session for restricted participants, the session that has already been started, will be described. In the following description of the second embodiment, functional components that are substantially the same as those in the first embodiment will be denoted by the same reference numerals as those used in the first embodiment, and description thereof will be omitted.

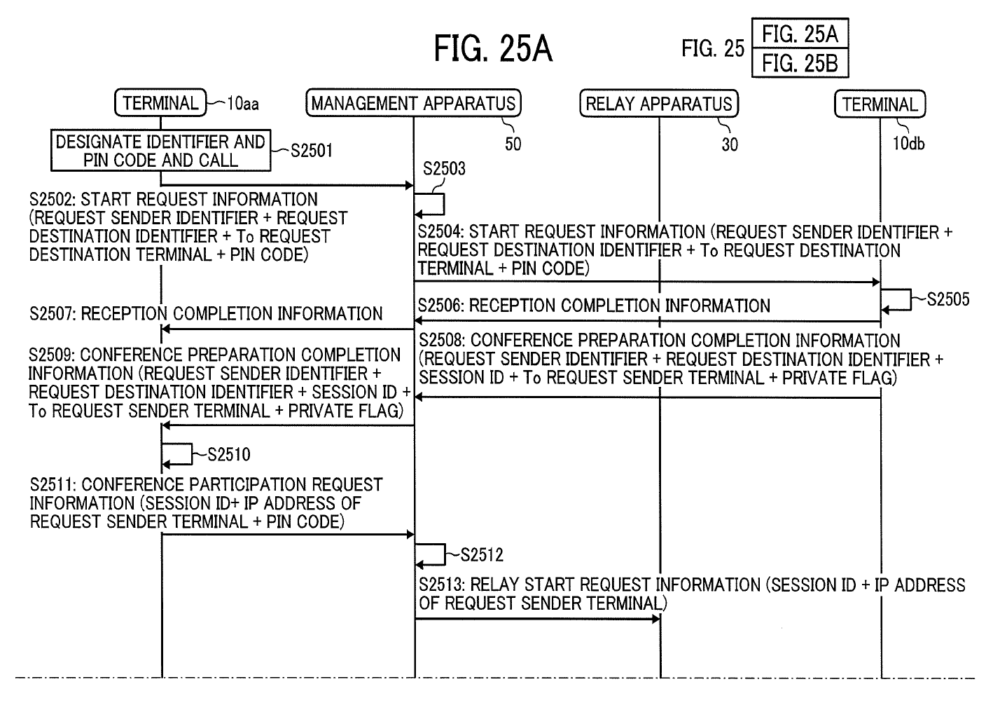

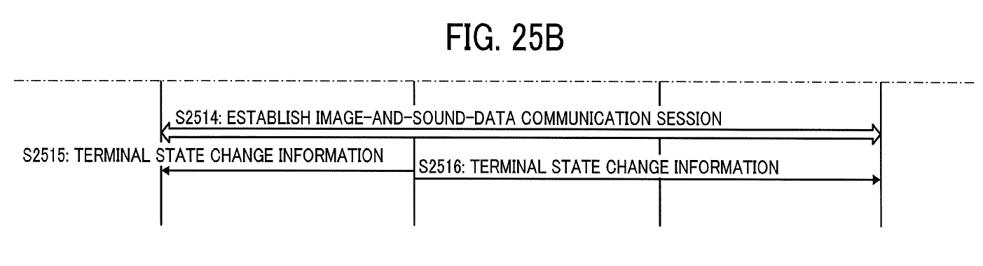

FIG. 25 illustrates a sequence of the operation of the communication system 1 according to the second embodiment. FIG. 25 illustrates a case in which the terminal 10aa issues a participation request for a conference for the terminal 10db that is already participating in a conference for restricted participants. In addition, FIG. 25 illustrates the operation of the communication system 1 performed if the identifier (the request destination identifier) that has been input to the terminal 10aa is absent in a counterpart list.

Since the process in steps S2501 to S2507 in FIG. 25 is substantially the same as the process in steps S1401 step S1407 in FIG. 14, description thereof will be omitted.

In this embodiment, the terminal 10db is participating in a conference to which a session ID has already been given. Thus, in FIG. 25, a process for generating a session ID and for notifying the terminals 10aa and 10db of the session ID is not performed.

Following step S2507 in which the terminal 10db transmits the reception completion information, the terminal 10db generates, by using the request generator 23, conference preparation completion information and transmits the conference preparation completion information to the management apparatus 50 (step S2508).

Since the process in steps S2508 to S2511 in FIG. 25 is substantially the same as the process in steps S1413 to S1416 in FIG. 14, description thereof will be omitted.

Upon the conference participation request information being received from the terminal 10aa, the participation determiner 59 of the management apparatus 50 determines whether the PIN code included in the conference participation request information is the same as the PIN code corresponding to the identifier (the request destination identifier) of the terminal 10db in the terminal management table 801 (step S2512). Here, description will be given by assuming that the participation determiner 59 determines that the PIN codes are the same.

Subsequently, the management apparatus 50 generates relay start request information and transmits the relay start request information to the relay apparatus 30 (step S2513). The relay start request information includes the session ID and the IP address of the terminal 10aa serving as the request sender terminal.

Since the process in steps S2513 to S2516 in FIG. 25 is substantially the same as the process in steps S1417 to S1420 in FIG. 14, description thereof will be omitted.

Note that in the example in FIG. 25, the identifier and the PIN code are input in step S2501. However, information to be input is not limited to these. In this embodiment, for example, only the request destination identifier that has been input may be accepted in step S2501 to perform a calling operation for the management apparatus 50, and the PIN code may be input in response to a request for inputting the PIN code in step S2510.

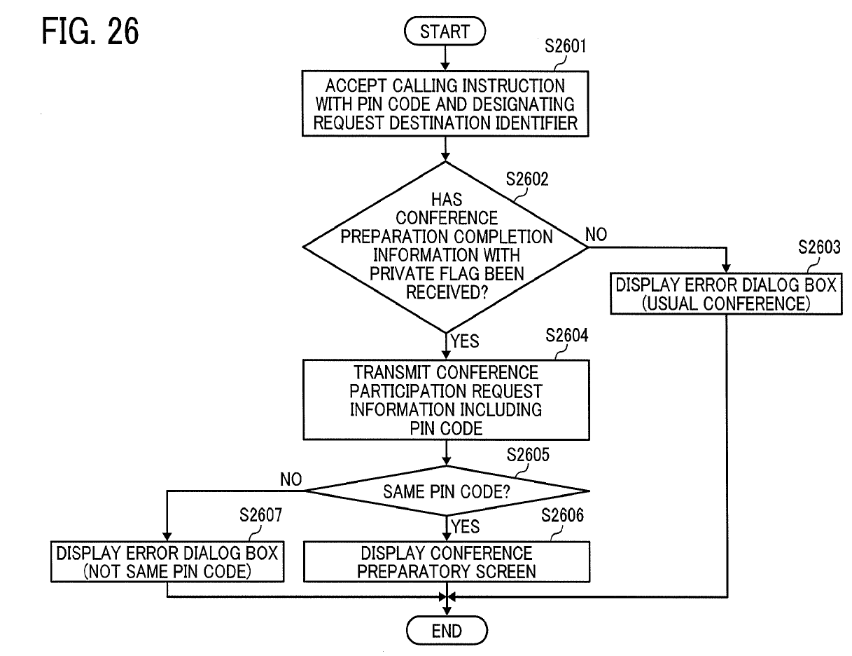

Next, the operation of the terminal 10aa according to this embodiment will be described with reference to FIG. 26. FIG. 26 is a flowchart illustrating the operation of the request sender terminal according to the second embodiment.

The operation input acceptor 12 of the terminal 10aa according to this embodiment accepts an input operation of a request destination identifier and a PIN code and a calling instruction (step S2601).

Subsequently, the type determiner 25 of the terminal 10aa determines whether conference preparation completion information with a private flag has been received (step S2602). In other words, the type determiner 25 determines whether the received conference preparation completion information includes a private flag.

If the conference preparation completion information does not include a private flag in step S2602, the display control 17 of the terminal 10aa causes a dialog box to be displayed, the dialog box including an error message indicating that the terminal 10db serving as the request destination terminal is performing a usual conference (step S2603), and the process ends. Note that the usual conference herein means a conference for which participants are not restricted.

If the conference preparation completion information includes a private flag in step S2602, the terminal 10aa generates, by using the request generator 23, conference participation request information including a PIN code and transmits the conference participation request information to the management apparatus 50 (step S2604).

Subsequently, the terminal 10aa determines whether the PIN code is the same as the PIN code corresponding to the terminal 10db in the determination performed by the participation determiner 59 of the management apparatus 50 (step S2605). In other words, the terminal 10aa determines whether the determination result obtained by the participation determiner 59 of the management apparatus 50 is “same”.

If “same” is obtained in step S2605, the display control 17 of the terminal 10aa causes a conference preparatory screen to be displayed (step S2606), and the process ends.

If “same” is not obtained in step S2605, the display control 17 of the terminal 10aa causes a dialog box to be displayed, the dialog box including an error message indicating that the PIN code is not the same (step S2607), and the process ends.

In the above manner, according to this embodiment, also when a terminal is to participate in a conference for restricted participants that has already been started, by only inputting a request destination identifier and a PIN code and issuing a calling instruction, a response in accordance with the state of the request destination terminal can be obtained. In addition, according to this embodiment, if the state of the request destination terminal is performing a conference for restricted participants and if the PIN codes are the same, the request sender terminal can directly participate in the conference for restricted participants.

Accordingly, according to this embodiment, an operation for participating in a session for restricted participants can be simplified.

### Third Embodiment

Now, a third embodiment will be described below with reference to some drawings. The third embodiment differs from the first embodiment in that a terminal participating in a session for restricted participants holds a PIN code. Accordingly, only different points from the first embodiment will be described in the following description of the third embodiment. Functional components that are substantially the same as those in the first embodiment will be denoted by the same reference numerals as those used in the first embodiment, and description thereof will be omitted.

In this embodiment, after a conference for restricted participants has been started, if a new terminal is to participate in the conference, a terminal participating in the conference notifies the new terminal of a PIN code.

In this embodiment, with this configuration, if a new terminal is to participate in a conference for restricted participants that has been started, there is no need for a participant of the conference to notify an operator of the newly participating terminal of a PIN code by using a unit other than the terminal.

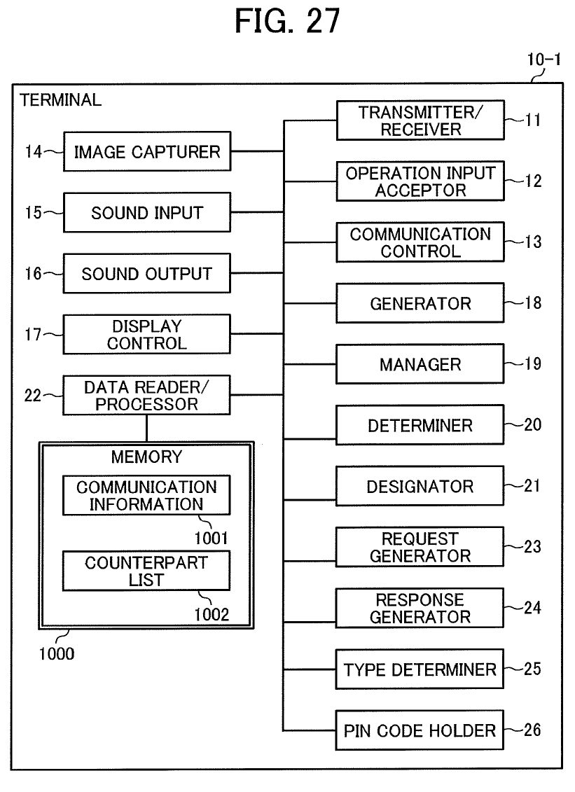

FIG. 27 illustrates a functional configuration of a terminal according to the third embodiment. A terminal 10-1 according to this embodiment includes a PIN code holder 26 in addition to the units included in the terminal 10 according to the first embodiment.

The PIN code holder 26 according to this embodiment holds a PIN code that is assigned to the terminal 10-1 until a conference for restricted participants ends.

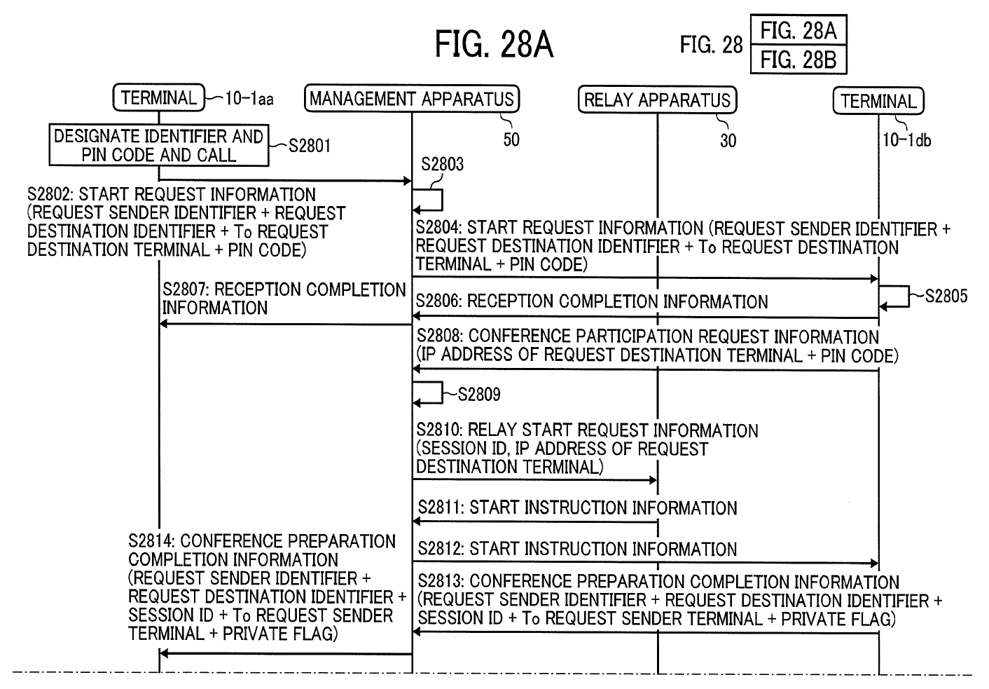

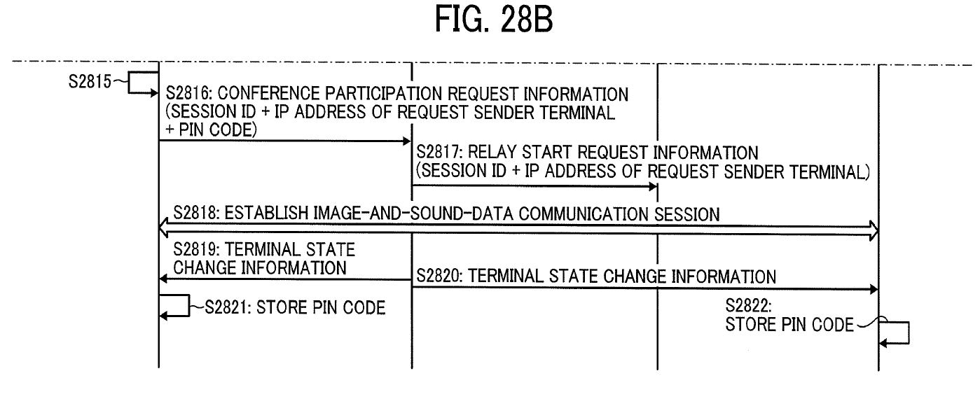

FIG. 28 illustrates a sequence of the operation of the communication system 1 according to the third embodiment. FIG. 28 illustrates the operation of the communication system 1 in which a terminal 10-1aa requests a terminal 10-1db to start communication such as a videoconference and starts a conference for restricted participants.

Since the process in steps S2801 to S2820 in FIG. 28 is substantially the same as the process in steps S1401 to S1420 in FIG. 14, description thereof will be omitted.

Following step S2820, the terminal 10-1aa holds a PIN code (step S2821). In addition, following step S2820, the terminal 10-1db holds a PIN code (step S2822).

In the above manner, in the example in FIG. 28, both the terminal 10-1aa that has started a conference for restricted participants and the terminal 10-1db hold a PIN code.

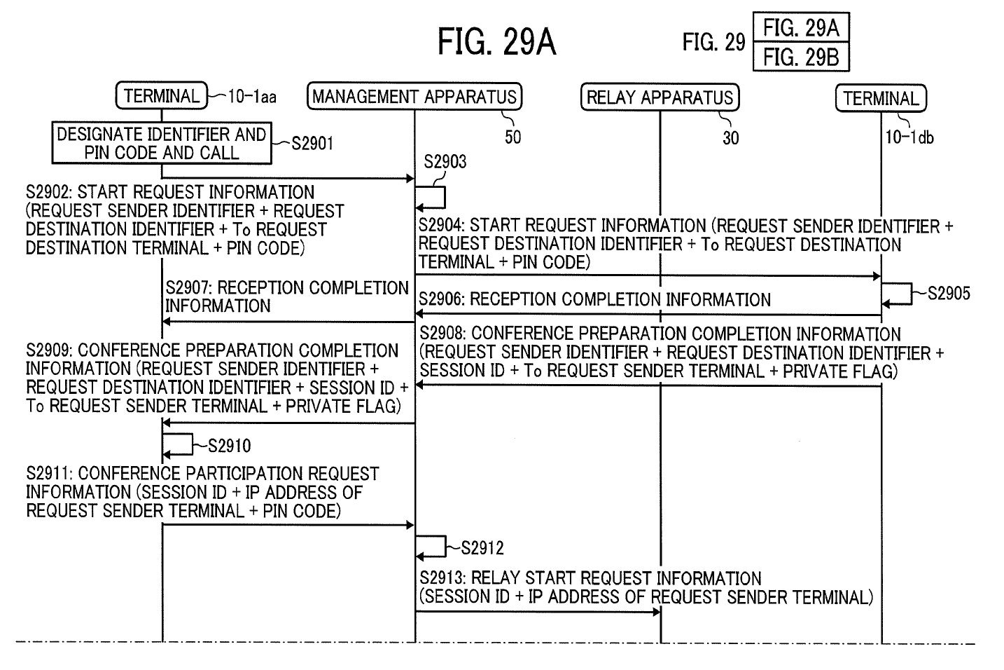

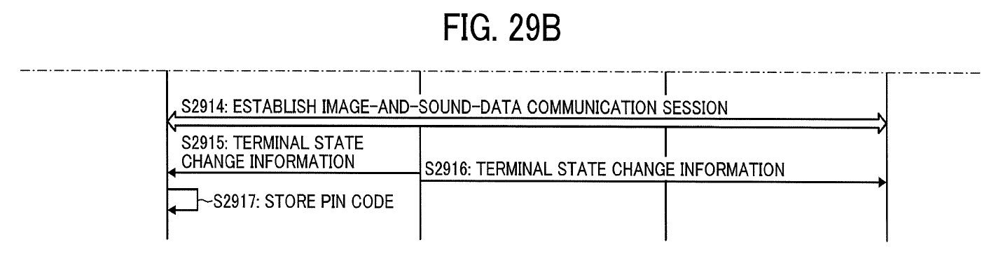

Next, in this embodiment, the operation of the communication system 1 in which the terminal 10-1aa participates in an active conference for restricted participants will be described with reference to FIG. 29.

FIG. 29 illustrates a sequence of the operation of the communication system 1 according to the third embodiment. Since the process in steps S2901 to S2916 in FIG. 29 is substantially the same as the process in steps S2501 to S2516 in FIG. 25, description thereof will be omitted.

Following step S2916, the PIN code holder 26 of the terminal 10-1aa holds the PIN code designated in step S2901 (step S2917).

Note that, in this step, the terminal 10-1db is participating in a conference for restricted participants, and accordingly, the terminal 10-1db already holds the PIN code.

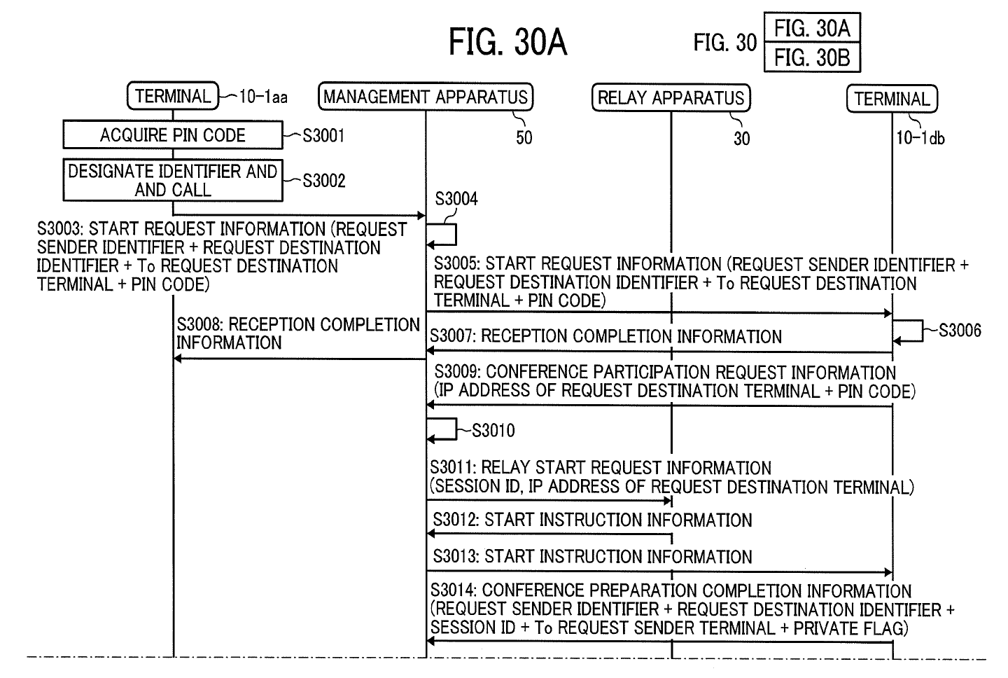

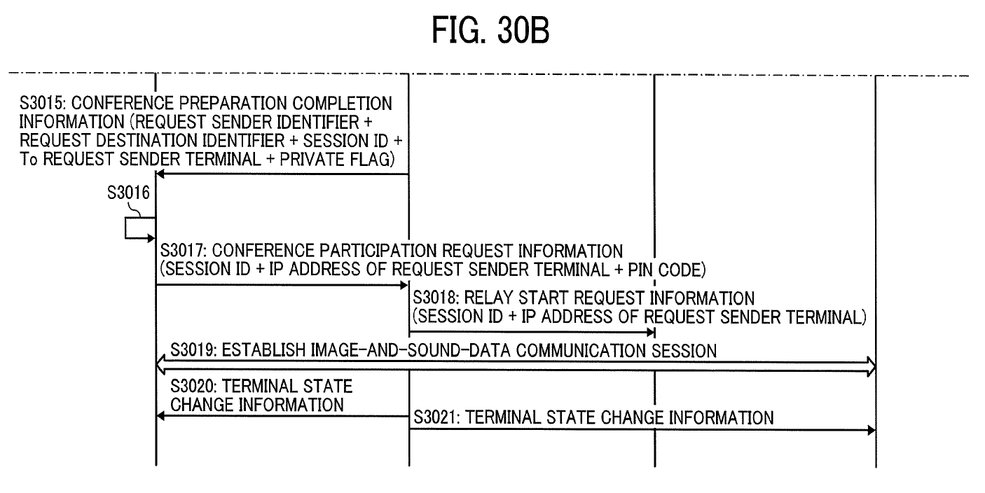

Next, the operation of the communication system 1 in which the terminal 10-1aa participating in a conference for restricted participants notifies the terminal 10-1db that newly participates in the conference for restricted participants, of a PIN code will be described with reference to FIG. 30.

FIG. 30 illustrates a sequence of the operation of the communication system 1 according to the third embodiment. The terminal 10-1aa according to this embodiment acquires a PIN code held by the PIN code holder 26 when allowing the terminal 10-1db to participate in the conference for restricted participants (step S3001).

Subsequently, the operation input acceptor 12 of the terminal 10-1aa accepts an input operation of the identifier (the request destination identifier) of the request destination terminal (the terminal 10-1db) performed by a user (step S3002).

Subsequently, the terminal 10-1aa generates, by using the request generator 23, start request information including the acquired PIN code and the identifier that has been input and transmits the start request information to the management apparatus 50 (step S3003).

Since the process in steps S3004 to S3021 is substantially the same as the process in steps S1403 to S1420 in FIG. 14, description thereof will be omitted.

Note that the identifier is designated and the PIN code is transmitted to the terminal 10-1db that newly participates in the conference for restricted participants so that the terminal 10-1db is notified of the PIN code in the example in FIG. 30. However, the notification method is not limited to this. The notification method for the PIN code may be, for example, a method in which the address of the request destination terminal is designated from an address list and in which the request destination terminal is notified of the PIN code by email.

In the above manner, according to this embodiment, a PIN code is held when a conference for restricted participants is performed. Accordingly, according to this embodiment, if a new terminal is to participate in the conference, there is no need to notify an operator of the newly participating terminal of a PIN code by using a unit other than the terminal.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An information processing terminal communicably connected with a communication management apparatus, the information processing terminal comprising:
a memory to store a counterpart list of one or more counterpart identifiers each representing a communication counterpart candidate of the information processing terminal, the one or more counterpart identifiers being associated with an identifier managed by the communication management apparatus; and
circuitry to:
accept a request destination identifier representing a counterpart information processing terminal that the information processing terminal requests for communication, and participation authentication information indicating that the information processing terminal has a participation authority to participate in communication with the counterpart communication terminal;
determine whether the request destination identifier matches any one of the counterpart identifiers on the counterpart list;
generate one of first communication start request information and second start request information according to a determination, each communication start request including the request destination identifier, the participation authentication information, and a request for communicating with the counterpart information processing terminal; and
transmit the communication start request information to the communication management apparatus,
wherein, based on the determination indicating that the request destination identifier matches any one of the counterpart identifiers on the counterpart list, the circuitry generates the first start request information addressed to the communication management apparatus, and
wherein, based on the determination indicating that the request destination identifier does not match any one of the counterpart identifiers on the counterpart list, the circuitry generates the second start request information addressed to the counterpart information processing terminal identified with the request destination identifier.

2. The information processing terminal according to claim 1,
wherein, in response to receiving communication preparation completion information indicating completion of preparation for starting communication from the counterpart information processing terminal,
the circuitry further determines whether the communication preparation completion information requests the participation authentication information, and
when the participation authentication information is requested, the circuitry generates communication participation request information including the participation authentication information, and transmits the communication participation request information to the communication management apparatus to start communication using the participation authentication information.

3. The information processing terminal according to claim 2,
wherein the circuitry generates the second start request information, when the request destination identifier is included in a terminal management table managed by the communication management apparatus but is absent in the counterpart list.

4. The information processing terminal according to claim 2,
wherein the circuitry generates the first start request information, when the request destination identifier is included in the counterpart list and the counterpart information processing terminal is available for communication.

5. The information processing terminal according to claim 2,
wherein, when the circuitry determines that the information processing terminal is available for communication at a time when a response to the generated one of the first start request information and the second start request information is received from the communication management apparatus,
the circuitry generates the communication participation request information including the participation authentication information.

6. The information processing terminal according to claim 5,
wherein, when the counterpart information processing terminal is currently participating in communication for which the participation authentication information is required, the communication preparation completion information received from the counterpart information processing terminal requests the participation authentication information.

7. The information processing terminal according to claim 5,
wherein, when the counterpart information processing terminal is currently participating in communication for which the participation authentication information is not required, the communication preparation completion information received from the counterpart information processing terminal does not request the participation authentication information.

8. The information processing terminal according to claim 2,
wherein the circuitry receives, from the communication management apparatus, counterpart list information regarding the one or more counterpart identifiers and state information indicating an operating state of each one of one or more communication counterpart candidates identified with the one or more counterpart identifiers, and
wherein the circuitry generates the counterpart list based on the counterpart list information and the state information being received.

9. The information processing terminal according to claim 2,
wherein the memory further stores the participation authentication information, and
wherein the circuitry generates one of communication start request information and the communication participation request information using the stored participation authentication information.

10. A communication system, comprising:
the information processing terminal according to claim 1; and
the communication management apparatus connected with the information processing terminal via a network, including:
a memory to store counterpart list information regarding the one or more counterpart identifiers and state information indicating an operating state of each one of one or more communication counterpart candidates identified with the one or more counterpart identifiers.

11. The communication system according to claim 10,
wherein the communication management apparatus further includes circuitry to determine which one of the first start request information and the second start request information is received, according to a destination indicated by the start request information.

12. An information processing method, performed by an information processing terminal communicable with a communication management apparatus, the method comprising:
storing in a memory, a counterpart list of one or more counterpart identifiers each representing a communication counterpart candidate of the information processing terminal, the one or more counterpart identifiers being associated with an identifier managed by the communication management apparatus;
accepting a request destination identifier representing a counterpart information processing terminal that the information processing terminal requests for communication, and participation authentication information indicating that the information processing terminal has a participation authority to participate in communication with the counterpart communication terminal;
determining whether the request destination identifier matches any one of the counterpart identifiers on the counterpart list;
generating one of first communication start request information and second start request information according to a determination, each communication start request including the request destination identifier, the participation authentication information, and a request for communicating with the counterpart information processing terminal; and
transmitting the communication start request information to the communication management apparatus,
wherein, when the determining indicates that the request destination identifier matches any one of the counterpart identifiers on the counterpart list, the generating generates the first start request information addressed to the communication management apparatus, and
wherein, when the determining indicates that the request destination identifier does not match any one of the counterpart identifiers on the counterpart list, the generating generates the second start request information addressed to the counterpart information processing terminal identified with the request destination identifier.

13. A non-transitory recording medium storing a plurality of instructions which, when executed by one or more processors, cause the processors to perform an information processing method, performed by an information processing terminal communicable with a communication management apparatus, the method comprising:
storing in a memory, a counterpart list of one or more counterpart identifiers each representing a communication counterpart candidate of the information processing terminal, the one or more counterpart identifiers being associated with an identifier managed by the communication management apparatus;
accepting a request destination identifier representing a counterpart information processing terminal that the information processing terminal requests for communication, and participation authentication information indicating that the information processing terminal has a participation authority to participate in communication with the counterpart communication terminal;
determining whether the request destination identifier matches any one of the counterpart identifiers on the counterpart list;
generating one of first communication start request information and second start request information according to a determination, each communication start request including the request destination identifier, the participation authentication information, and a request for communicating with the counterpart information processing terminal; and
transmitting the communication start request information to the communication management apparatus,
wherein, when the determining indicates that the request destination identifier matches any one of the counterpart identifiers on the counterpart list, the generating generates the first start request information addressed to the communication management apparatus, and
wherein, when the determining indicates that the request destination identifier does not match any one of the counterpart identifiers on the counterpart list, the generating generates the second start request information addressed to the counterpart information processing terminal identified with the request destination identifier.
